(19) United States
(12) Patent Application Publication
(10) Pub. No.: US 2008/0103896 A1
(43) Pub. Date: May 1, 2008

(54) SPECIFYING, NORMALIZING AND TRACKING DISPLAY PROPERTIES FOR TRANSACTIONS IN AN ADVERTISING EXCHANGE

(75) Inventors: Gary W. Flake, Bellevue, WA (US); Christopher A. Meek, Kirkland, WA (US); Jody D. Biggs, Redmond, WA (US); David Max Chickering, Bellevue, WA (US); Brett D. Brewer, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/735,737

(22) Filed: Apr. 16, 2007

Related U.S. Application Data
(60) Provisional application No. 60/862,969, filed on Oct. 25, 2006.

(51) Int. Cl. G06Q 30/00

(52) U.S. Cl. 705/14

(57) ABSTRACT

For a multi-party advertising exchange including advertising and publishing entities, each participant can specify one or more display properties as requirements or definitions for advertising transactions in the exchange. The disparate display properties of multiple participants are normalized within the advertising exchange to a common vocabulary by translating the display properties to a common set of representations within the exchange enabling the comparison of a first set of display properties to a second set of display properties. The invention also optionally records the performance of advertising as a function of display properties over time so that optimal display strategies can be determined by participants with access to the performance information. Various system refinements are provided and disclosed according to a host of optional embodiments.

### TECHNICAL FIELD

The subject disclosure relates to the specification, normalization and tracking of display properties for advertising transactions according to a common vocabulary in online advertising architectures and environments.

### BACKGROUND

Conventionally, large web search engines have sold advertising space based on keyword-driven search results. For example, Yahoo! conducts auctions for certain keywords, and the highest bidders have their ads placed on pages containing Yahoo! search results, or they obtain preferred placement among the search results, i.e., at the top of the results list.

As web advertising has developed, a number of companies are acquiring large publisher bases from which they can sell advertisements. For instance, Google is signing up publishers into their AdSense ad network to broker publishing space from the publishers to a set of participating advertisers bidding for and purchasing the advertising space. Advertisers pay Google to serve advertisements to participants of the AdSense network. Google then pays some or all of the advertising revenue to the individual publishers. For example, a publisher in the AdSense network may have an article on its website that talks about digital cameras, and Google's AdSense displays digital camera advertisements from advertisers in the AdSense network on that website. Google auctions off the “digital camera” keyword to advertisers in its AdSense network and displays ads from the highest bidders.

However, there are a number of problems with this proprietary ad network model. First, companies that are building ad networks have an inherent conflict of interest because, as a broker for advertising deals, they represent both the publisher and the advertiser. Second, because there are multiple companies that are creating ad networks, advertisers have the burden of managing buys across many ad networks, which results in significant cost and complexity to the advertiser. Third, because publishers are for all practical purposes locked into a single ad network due to legal restrictions when signing up, the advertiser competition is limited, which results in lower return for the publishers. Fourth, the lack of general standards around terms and conditions, and behavioral segmentation is a major obstacle to reaching the full market value of online display advertising. There is also no current standardization across publishers for accepted media types and ad formats. Fifth, smaller publishers currently have very little power individually, even if they serve a hard-to-reach audience. Additionally, ISPs and other owners of large user databases are not realizing the full value of the information they have due to privacy concerns and lack of a proper marketplace.

For instance, elaborating on the lack of standards around terms and conditions of existing advertising transactions, there are a variety of disparate items in an advertising exchange that should be able to be compared, except today, they cannot be compared because of disparate definitions set forth by different participants and different standards followed by different participants.

An example of this lack of standards is with respect to the way that display properties for advertising are defined, or not defined, by participants in an exchange. Oftentimes, when there are multiple advertisers bidding for the same publisher space, or when multiple publishers are competing for the same advertisers, each participant to the transaction may have different ways of defining display properties and other presentation rules for the inventory involved. Today, these display properties and other presentation rules, if they are even specified at all, manifest themselves in a variety of ways, and formats, creating a lot of uncertainty over the way advertising inventory is to be displayed as part of an advertising transaction.

As a relatively simple example, when cost per impression (CPI) is a given metric for a revenue event in an advertising transaction, the advertiser bears a lot of the risk because there is no guarantee that an impression will be fruitful in terms of desired sales. Compounding the problem is that the advertiser today does not know the difference between the ways that competing publishers will display the advertising at issue.

Put simply in terms of an example, if the advertising will be displayed in an obscure and cluttered position by a first publisher, but in a prominent and uncluttered position by a second publisher, the advertiser will be willing to pay more for impressions displayed by the second publisher due to the higher quality of the display. Today, unfortunately, there is no way to compare different display methodologies by different publishers, or to specify advertiser requirements according to a language that defines display properties for advertising, and so advertisers, by in large, must guess at other participants' display properties and their impact. Yet, the quality and other characteristics of the display relate to the utility of advertising to the respective participants, and so this information would be useful to expose.

Thus, what is desired for an online advertising exchange is a way to specify or define advertising display properties according to a common language, so that different display properties for different participants are normalized for comparison across competing participants to advertising transactions.

As another example, when cost per click (CPC) is a given metric for a revenue event in an advertising transaction, while the concerns with respect to bearing the risk of impressions are not necessarily present (because a user, by definition, has clicked through to a target page, triggering the revenue event), it would still be desirable to be able to normalize different display procedures with a common vocabulary within an advertising exchange.

As an example, participants to CPC-based transactions would benefit from normalization of display properties because the set of display properties of a publisher can serve as a proxy for the quality of that publisher, which may impact the decision of a prospective advertiser in an advertising transaction. For instance, if it could be ascertained that a publisher generally only places advertising in an obscure location overshadowed by the publisher's own content, even though the advertiser bears less risk under CPC terms than CPI terms, the advertiser may still wish to take into account the lack of quality of the publisher in its advertising decisions. Yet, such information is difficult to ascertain in today's advertising transactional environments.

Another way that participants can benefit from information about display properties across publishers in the exchange is with respect to participants who might prefer volume over quality. For instance, if an advertiser were bidding CPC for relatively unknown publishing inventory, the advertiser may be hesitant to bid high enough to be placed in a prominent position because it might cost too much relative to an overall advertising budget. Instead, the advertiser might actually prefer “bad” display attributes because per unit cost, the advertiser may wish to maximize impressions to the most users. For instance, “flickering” mortgage advertisements may actually prefer low cost placement, and thus inventory with poor display properties, as determined by analyzing the normalized collection of display property information stored by the exchange, can be taken into account in pricing models used by the exchange to satisfy such participants interested in volume.

This highlights that it would be further desirable to be able to define display properties of different participants to advertising transactions of an advertising exchange according to a common language, and then to automatically track the performance the advertising as correlated to, or normalized by, the display properties that apply to the performance of advertising. This would beneficially allow different participants to compare the performance of the same or similar advertising with respect to the different display properties of different publishers, or the performance of different advertising under conditions of similar display properties. The comparison would allow participants to advertising transactions to make better, more rational decisions about the expected return on investment for advertising dollars for different display circumstances, and to achieve expected results per advertising spend with less variance.

The above-described deficiencies of current advertising environments are merely intended to provide an overview of some of the problems of today's advertising environments, and are not intended to be exhaustive. Other problems with the state of the art may become further apparent upon review of the description of various non-limiting embodiments of the invention that follows.

### SUMMARY

For a multi-party advertising exchange including advertising and publishing entities, the invention enables each participant to specify one or more display properties as requirements or definitions for advertising transactions in the exchange. The disparate display properties of multiple participants are normalized within the advertising exchange to a common vocabulary by translating the display properties to a common set of representations within the exchange enabling the comparison of a first set of display properties to a second set of display properties. The invention also optionally records the performance of advertising as a function of display properties over time so that optimal display strategies can be determined by participants with access to the performance information. In other embodiments, participants can explicitly, or implicitly, specify a target set of display properties to the exchange, whereby based on the target set, the exchange automatically tailors a set of advertising transactions with respect to display properties that optimize for one or more objectives of the participant, and optionally generates an advertisement with optimized display properties.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

Various embodiments of the specifying and normalizing of display properties for online advertising in accordance with the present invention are further described with reference to the accompanying drawings in which:

FIG. 1 is a block diagram of a computing system environment suitable for use in implementing the present invention;

FIG. 2 illustrates a distributed architecture for online advertising according to embodiments of the present invention;

FIG. 3 illustrates one example of the flow of data within architecture 200 according to embodiments of the present invention;

FIG. 4 illustrates a flowchart of the operation of an exchange according to embodiments of the present invention;

FIG. 5 illustrates a flowchart of the operation of an audience data broker according to embodiments of the present invention;

FIG. 6 is an exemplary non-limiting block diagram of embodiments of an online advertising exchange in accordance with the invention;

FIG. 7 is another exemplary non-limiting block diagram of embodiments of an online advertising exchange in accordance with the invention;

FIG. 8 is an exemplary block diagram illustrating an alternate embodiment of an online advertising exchange in accordance with the invention;

FIG. 9 illustrates another exemplary block diagram illustrating an alternate embodiment of an online advertising exchange in accordance with the invention;

FIG. 10 illustrates exemplary processes for conversion tracking in a distributed online advertising exchange;

FIG. 11 illustrates non-linear weighting of conversion rates as a function of display properties in an exemplary non-limiting embodiment of the invention;

FIG. 12 illustrates another exemplary block diagram illustrating the normalizing of disparate broker rules in an online advertising exchange in accordance with the invention;

FIGS. 13A, 13B and 13C illustrate exemplary normalization of disparate formats for expressing display properties for transactions in an online advertising exchange in accordance with the invention, and subsequent conversion tracking as a function of display properties;

FIGS. 14A, 14B and 14C are exemplary, non-limiting block diagram illustrations of normalizing transactions in an online advertising exchange based on display properties specified by the participants, and subsequent conversion tracking as a function of display properties, in accordance with the invention;

FIG. 15 is a block diagram that shows the ability of participants to specify one or more display properties to an advertising exchange or federation in accordance with the invention.

FIGS. 16A and 16B illustrate exemplary tools and ways for participants to express one or more display properties for normalization by an online advertising exchange in accordance with the invention;

FIGS. 17A and 17B illustrate exemplary ranges or continuums along a spectrum for defining one or more display properties in accordance with the invention;

FIG. 18 is a block diagram illustrating the filtering or weighting of display properties that may be specified by a participant to an online advertising exchange in accordance with the invention;

FIG. 19 is a flow diagram illustrating an exemplary process for receiving and normalizing display properties input by participants to an exchange in accordance with the invention; and

FIG. 20 is a flow diagram illustrating an exemplary process for tracking display properties as a function of display properties for transactions of an exchange in accordance with the invention.

### DETAILED DESCRIPTION

### Overview

In various non-limiting embodiments, the invention is described in the context of a distributed architecture for online advertising, i.e., a market mechanism that manages the exchange of advertising goods among multiple participants on the advertising and/or publishing side. For instance, for a multi-party advertising exchange, the invention enables each participant to specify display properties for advertising transactions as requirements to or definitions for advertising transactions according to a common language used within the exchange for defining advertising display properties.

This allows disparate display properties of multiple participants to be normalized within the advertising exchange enabling the comparison or translation of a first set of display properties to a second set of display properties in quantifiable terms. Moreover, the invention enables the automatic tracking of display properties associated with publishing of advertising so that better performance data is available from which to evaluate and make advertising decisions based on the way that advertising is presented to the end user.

Overall, increasing the amount of knowledge of parties to a transaction makes for a more efficient transaction since knowledge can reduce uncertainty and risk in decision making by the parties. In this respect, the invention increases the ability of participants to an advertising exchange to make more rational decisions about advertising transactions vis-a-vis other participants' display properties, and via the ability to track this information over time according to a common vocabulary enabling comparison of the performance of different display properties. As a result, the advertising marketplace is better defined as between individual participants, making for more efficient and rational transactions among those participants, and yielding a more efficient marketplace for all.

In other embodiments, participants can explicitly, or implicitly, specify a target set of display properties to the exchange, whereby based on the target set, the exchange automatically tailors a set of advertising transactions with respect to display properties that optimize for one or more objectives of the participant. This enables participants to specify, for instance, that they prefer “low-clutter” publishing inventory, automatically triggering the exchange to display advertising inventory with a “low-clutter” filter over display properties. Alternatively, an advertiser may actually wish for “high-clutter” space for different reasons.

In other exemplary, non-limiting embodiments of the invention, an advertiser can specify, e.g., via filling out a form, a set of requirements and goals for an advertising transaction of interest to the advertiser. The exchange then informs the advertiser, based on an analysis of the advertiser's goals and advertising requirements relative to performance information tracked within the exchange, of the best display properties for the advertiser, optionally displaying a set of advertising inventory for purchase within the exchange that satisfy the best display properties for the advertiser.

In various non-limiting embodiments, an advertising system to facilitate trading of advertising includes (A) a publisher broker to represent publishers that determines an ask for an advertisement space on the publishers' inventory, such as a webpage, (B) an advertiser broker to represent advertisers that manages the advertisers' bids for the advertisement space and (C) an exchange to facilitate a transaction for the advertisement space between the publisher broker and the advertiser broker.

To specify display properties for advertising transactions by an exchange participant, a tool is provided in accordance with the invention for defining one or more display properties of a participant to the exchange, such as a publisher broker or advertiser broker. For instance, the tool enables participants to explicitly specify one or more pre-defined categories of display properties, or presentation requirements, for advertising according to a standard vocabulary for defining display properties for advertising.

In other aspects, the invention enables direct comparisons of disparate display properties of different participants by normalizing the disparate display properties to a standard display properties representation within the advertising exchange. Any method for specifying display properties for advertising and/or further subdividing the potential display factors may be implemented for the common vocabulary utilized in the exchange. In one non-limiting embodiment, participants specify different display properties according to a predetermined set of categories of display properties that are relatively established in the advertising industry. For instance, the terms “banner ad,” “pop-up” or “toast” are example categories that have a well known meaning to those in the advertising technological arts in terms of underlying display characteristics and requirements, and thus a predetermined set of categories may comprise such different categories as defined in the industry, and at any level of granularity.

In another embodiment, different parties' display properties may be specified according to different vocabularies by different participants, but the exchange operates to normalize the display property requirements or definitions of the different parties into a common language so that disparate display requirements or definitions of different participants can be compared directly. For instance, any party can specify a set of display properties of importance to the party, and based on known mappings between different display settings, display properties across different parties can be normalized in the exchange. Also, optionally, when transacting with a third party, a party's view into display properties of the third party can be transformed or mapped from the common vocabulary used to represent display properties within the exchange to the language of the display properties used by the party.

In this regard, each party can specify respective maximization functions based on different display properties of importance to that party. Since each party has unique business goals and objectives, a wide variety of objectives may be toggled, or modified in accordance with the invention to specify display properties on a per party basis.

In another embodiment, conversion tracking relative to display properties is enabled for the exchange of the invention to provide a more solid understanding of conversion rate for advertising based on the set of display characteristics that were present at the time of publishing. In essence, it is known that by increasing one's conversion rate for advertising, a marketer can lower the cost per acquisition without changing the cost paid for traffic. Even a small increase in conversion rate can have a dramatic profit impact, and so it is desirable to find publishing space with a high expected conversion rate. With conversion tracking provided in the distributed framework for online advertising in accordance with the invention, pricing can be made more accurate because conversion information is available across parties. In this respect, lousy presentation of an advertisement will eventually be priced lower due to lesser demand for lousy presentation, which will encourage publishers to maintain the quality of their eyeball space. Under free market principles, conversion tracking information about how certain advertisements perform under certain display characteristics will help advertisers more accurately “get what they pay for,” increasing certainty of participation in the advertising exchange.

A wide variety of display properties may be specified or normalized in accordance with the invention. For instance, display properties for advertising may include, but are not limited to, at varying degrees of generality: position, timing, duration, type or kind of advertising as known in the industry, e.g., pop up, pop under, pop over (e.g., Flash media), banner ads, right rail (e.g., for sponsor ads), “above the fold,” Web search display, bottom ads (e.g., South position), Toast, Top Left, Top Right, digital billboard, top of page before content, top of page after content, Blog ad space (e.g., ads for MSN's MySpace pages), etc., number of or area in pixels, shape, amount of clutter, speed of display, quality and size of typefont, or any other parameter that specifies an aspect relating to the presentation experience for advertisements displayed at a publisher's inventory. This list is merely exemplary, and any other factor affecting advertising presentation may also form the basis for a type of display property that may be specified or normalized in accordance with embodiments of the invention herein.

A simplified overview has been provided in the present section to help enable a basic or general understanding of various aspects of exemplary, non-limiting embodiments that follow in the more detailed description and the accompanying drawings. This overview section is not intended, however, to be considered extensive or exhaustive. Instead, the overview presents some concepts related to some exemplary non-limiting embodiments of the invention in a simplified form as a prelude to the more detailed description of these and various other embodiments of the invention that follow.

### Exemplary Operation Environment(s)

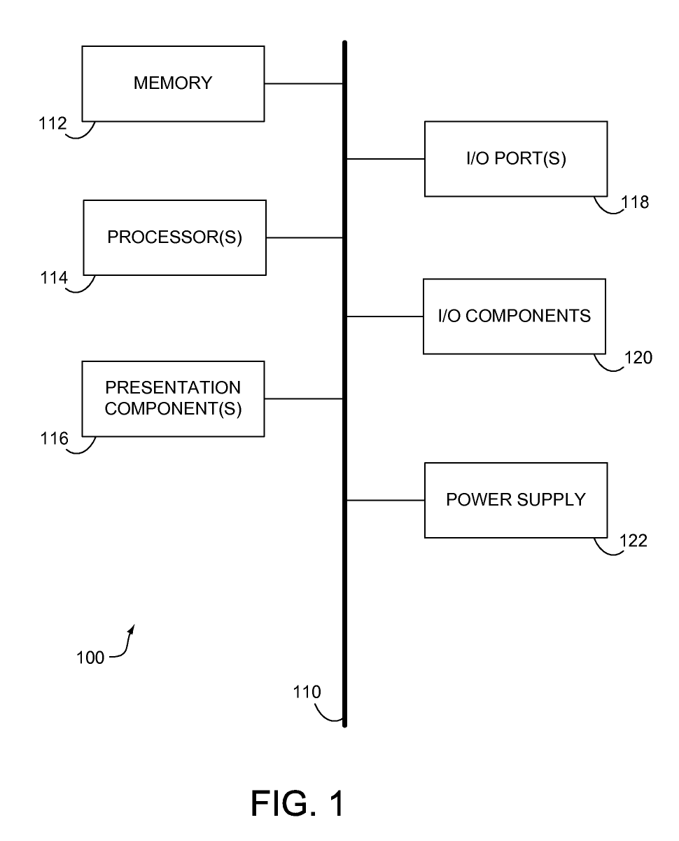

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated. In accordance with the invention, participants can communicate with an advertising exchange via one or more computing devices 100, and the advertising exchange may also comprise one or more computing devices 100, in order to carry out one or more aspects of the invention described in detail below.

In this regard, the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following elements: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory, or otherwise communicate with memory. It should be noted that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

### Exemplary Architecture(s) for Online Advertising

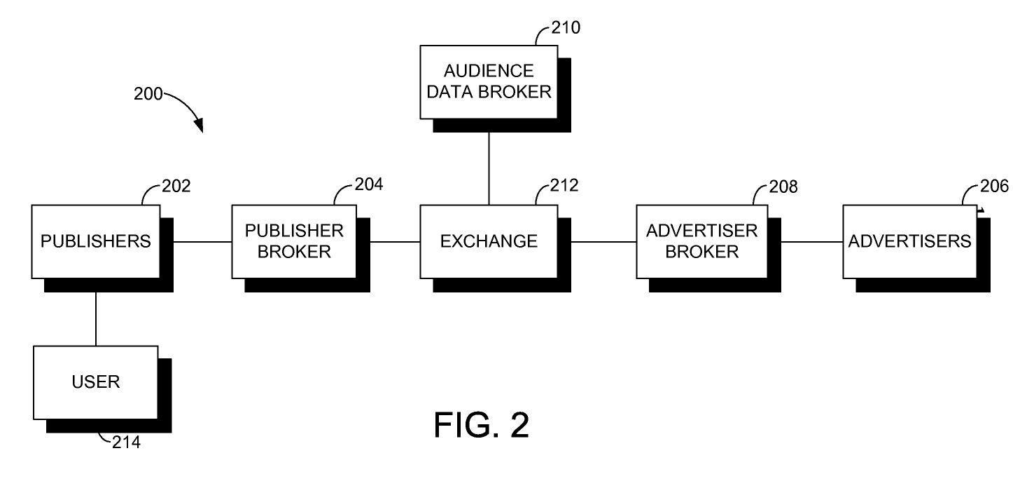

Exemplary online advertising environments or architectures in which one or more of the various embodiments of the specification, normalization and tracking of performance of participant display properties of the present invention may be deployed or implemented are now described. For instance, FIG. 2 illustrates an exemplary distributed architecture 200 for online advertising, which comprises publishers 202. For purposes of explanation only, publishers 202 will be discussed herein as a group of any number of publishers. However, embodiments of the present invention are not limited to a group of publishers, as a single publisher is sufficient. Also, embodiments of the present invention are not limited to a single group of publishers, as any number of groups of publishers may be present in architecture 200.

In an embodiment, each publisher is a content provider. For example, a construction worker who operates a single page website on which he posts a weblog (blog) may be a publisher. In another example, a media company such as Disney, who operates a huge website with many pages of content may also be a publisher. Publishers 202 is intended to represent any number of types, sizes, sophistication levels, etc. of publishers. In an embodiment, publishers 202 desire to sell advertisement space on their websites to advertisers 206 (discussed below).

Architecture 200 also comprises publisher broker 204. For purposes of explanation only, only one publisher broker will be discussed herein. However, embodiments of the present invention are not limited to a single publisher broker, as any number of publisher brokers may exist. In an embodiment, publisher broker 204 is an aggregator of publishers. Specifically, publisher broker 204 is an entity that represents publishers 202 with the goal of maximizing ad revenue, ensuring quality ads, etc. Publisher broker 204 breaks the conflict of interest that is inherent in systems such as Google's AdSense by solely focusing on managing publishers 202's yield. Publisher broker 204 allows small and mid-size publishers (such as those that may be represented by publishers 202) to aggregate in order to drive higher yield for themselves. In an embodiment, publisher broker 204 maintains a user interface through which it interacts with publishers 202 and through which it manages publishers 202's preferences.

In an embodiment, publisher broker 204 comprises a publisher center and a publisher delivery system. The publisher center allows publishers to manage their preferences. The publisher delivery system is used to calculate the ask for a given page view on the publisher's site, and potentially enrich the available user data in the request. In an embodiment, the ask is an asking price. However, embodiments are not so limited, as the ask may be, e.g., a minimum cost-per-click, minimum relevance, some other performance metric, etc.

The publisher center establishes traffic inventory groupings in the system and sets asks. When a user makes a page request to the publisher, the publisher populates their page with some scripting that sets up a call to the publisher broker. The publisher may add in some information about the user to the call to the publisher broker (the incentive would be that more publishers would want to use a publisher broker that had this sort of value added service). The publisher broker determines what the ask should be for a particular request, given the user information present, the inventory grouping that the request falls into, and the rules the publisher has set up around that information. Additionally, the publisher broker will pass along the maximum amount that the publisher is willing to pay to have any unknown data attributes about the user populated for this request. Finally, the publisher broker encodes this information into a request URL that it sends back to the user as a redirection URL. When all transactions have occurred in the exchange (see below), a call back is provided to the publisher broker stating whether and how many ads were displayed, what the publisher broker can expect in terms of a payment, and which incremental attributes about the user were filled, for instance, by an audience broker (see below).

Architecture 200 also comprises advertisers 206. For purposes of explanation only, advertisers 206 will be discussed herein as a group of any number of advertisers. However, embodiments of the present invention are not limited to a group of advertisers, as a single advertiser is sufficient. Also, embodiments of the present invention are not limited to a single group of advertisers, as any number of groups of advertisers may be present in architecture 200.

In an embodiment, each advertiser purchases ad space on websites, though any digital representation of advertising can be included in embodiments of the invention. For instance, in addition to any digital representation of advertising, an advertising exchange may reflect the display properties of billboards, printed media and publications, TV, Radio, etc., or any traditional means for publishing advertising, as long as the advertising is purchased and sold within the exchange. In this respect, any of the foregoing media can be characterized by display properties, and with the tracking of performance as mapped to display properties.

For example, a local businessperson who operates a website for her small flower shop and who advertises on a neighborhood homeowners' association website may be an advertiser. In another example, a massive corporate entity such as General Motors, which has thousands of products and services, and which advertises on thousands of automotive-related websites may also be an advertiser. Advertisers 206 is intended to represent any number of types, sizes, sophistication levels, etc. of advertisers. In an embodiment, advertisers 206 desire to pay money to place ads on publishers 202's websites.

Architecture 200 also comprises advertiser broker 208. For purposes of explanation only, only one advertiser broker will be discussed herein. However, embodiments of the present invention are not limited to a single advertiser broker, as any number of advertiser brokers may exist. In an embodiment, advertiser broker 208 is an aggregator of advertisers. Specifically, advertiser broker 208 is an entity that represents advertisers 206 with the goal of optimizing advertisers 206's spending and placing monetary values on displaying advertising of a particular format, on a particular website, to a particular audience. In an embodiment, advertiser broker 208 maintains a user interface through which it interacts with advertisers 206, and through which it manages advertisers 206's preferences, such as preferences for particular user data attributes. However, embodiments of the present invention are not limited to any particular advertiser preferences.

In an embodiment, an advertiser sets up ads in the advertiser broker system, but has no further interaction with the exchange (see below) or end user until such a point as the end user clicks on their ad. This means that the advertiser does not see any user attributes that have been populated by audience data brokers (see below) as part of the exchange transaction. In an embodiment, the exchange (see below) carries enough information to allow for advertisers to setup self-optimizing campaigns based only on landing URLs, creatives, and campaign goals. Similarly, algorithms can be run on advertiser landing URLs to choose possible subsets of audience attributes as well as relevant topics (keywords, categories, and content pages). The available features can then be selected to maximize the campaign goals, for example branding campaigns would minimize the amount paid per impression and maximize the coverage and inventory quality. A sales campaign on the other hand would be selected to track conversions and maximize the number of high value conversions for the existing advertiser budget.

Architecture 200 may also comprise audience data broker 210. For purposes of explanation only, only one audience data broker will be discussed herein. However, embodiments of the present invention are not limited to a single audience data broker, as any number of audience data brokers may exist. In an embodiment, audience data broker 210 is an aggregator of user data providers. A user data provider is any entity that maintains any partial information that can be referred back to an individual user (such as one of users 214, discussed below) for advertising purposes.

Publishers may be interested in the audience information, independently of the advertisers on the advertising exchange. For example, a publisher may want to show different content on their web site to users based on the gender of the users, e.g., to attract more people to the site. In this regard, the publisher may be interested in buying audience information for presentation purposes, independently of the advertisers in the exchange. Thus, both advertisers and publishers participating in an advertising exchange are interested in audience information.

For example, user data may comprise demographic, psychographic, and behavioral information. More specifically, for example, user data may comprise age, gender, wealth index, interests, shopping habits, etc. However, embodiments of the present invention are not limited to any specific type of user data. In an embodiment, audience data broker 210 is any large user data aggregator, such as PayPal, Visa, Yahoo!, Verizon, as well as an aggregate of smaller user data providers. Any online store that collects user data can function as audience data broker 210 by providing user location level and user purchase pattern level information. This information can be aggregated with demographic profiles from small web email providers to form more comprehensive user descriptions.

In an embodiment, audience data broker 210 enriches information regarding a user viewing one of publishers 202's web pages. In an embodiment, audience data broker 210 does not disclose any personally identifiable information about the user. In an embodiment, audience data broker 210 accomplishes this by performing a private user ID lookup and passing back a set of aggregate user attributes that could be consumed by advertisers 206 and advertiser broker 208. This user attribute enrichment increases the value of the display of the ad to advertisers 206, helps produce more relevant ads to consumers, and creates a more complete picture of the user for ad serving purposes without violating the user's privacy. The aggregation across different providers serves two independent roles, in an embodiment: (1) it creates a comprehensive view of the audience landscape, and (2) it thickens the data sources to allow for anonymization and preservation of user privacy.

In an embodiment, audience data broker 210 receives direct payment for even small and/or partial user attributes. By participating in architecture 200, audience data broker 210: (1) is paid for its information, (2) can enrich its information (even redundant data providers are useful for scoring purposes), and (3) can verify its information (providers with poor quality of data will gain insight and will be able to actively address data quality issues). In an embodiment, audience data broker 210 receives a request from publisher broker 204 proxied by exchange 212 (explained in greater detail below). Audience data broker 210 appends known user attributes into this request for the consumption of advertiser broker 208. Audience data broker 210 does not know the page that the user is on from publisher broker 204, and audience data broker 210 will not pass any user identifiers to advertiser broker 208.

In an embodiment, audience data broker 210 comprises a user data recorder to record user information into the exchange (discussed below) and a user data delivery system to respond to requests for the user information. In an embodiment, the user data recorder informs the exchange that the audience data broker knows something about a user, through whatever means that may be. To do this, when the audience data broker has contact with a user that they know something about, the audience data broker can either set up a single pixel gif call to the exchange that the user will perform, or the audience data broker can redirect the current user request to the exchange, along with the information and a destination URL for the exchange to redirect the user to afterwards. In each case, whatever information or data key the audience data broker wishes to receive back is expected to be enough so that the audience data broker can answer user data delivery system requests for the use. In an embodiment, the information passed to the exchange is signed in a manner that proves the identity of the audience data broker to the exchange. In an embodiment, the exchange, upon verifying the identity of the audience data broker, will set a cookie to the user's browser with the name of the cookie identifying the audience data broker, and the cookie value being the information provided. In an embodiment, when the exchange receives an ad request from a user (the user having been sent to the exchange from a publisher broker), if there are any user data attributes that the publisher is willing to pay an additional amount for, then the cookies for all audience data brokers are read from the user's browser. For each audience data broker identified by a cookie, if the audience data broker is currently live, the exchange will send a request to that audience broker with the cookie value and any unknown data attributes which the publisher is willing to pay to have provided. The audience data broker then responds back, including the information for as many attributes as they know, along with the price they are asking for to allow it to be used.

In an embodiment, audience data brokers can participate in an advertiser auction and get paid directly through an advertiser bid with no audience data requests from the publisher broker. This would be considered a “publisher blind” audience data delivery. If an advertisement bid meets and exceeds a publisher requested minimum, then the bid remainder left after publisher ask can be used to acquire user data and maximize advertiser ROI (return on investment) using tighter targeting. The exchange provides a call back to the winning audience data broker(s) letting them know what attributes they won on, and what amount they will be paid for that information.

For the avoidance of doubt, exemplary embodiments herein describe an audience broker in the context of advertisers benefiting from the audience information output by the audience broker, however, as noted earlier, publishers also benefit from audience information. For instance, in addition to other utility functions or biases expressed by a publisher to an online advertising exchange in accordance with the invention, the publisher's utility function might be expressed as a function of a specific user. For example, a publisher might want all the advertisements to be “age appropriate” for the users of the publisher's site.

Given that publishers and advertisers can apply payments directly to audience data brokers for specific information, in an embodiment, there is a verification and rating process for audience data brokers. Multiple audience data brokers will be competing for the same service. In an embodiment, competition is performed based on ask, but also based on quality of data. Advertisers will have transparency into the publisher broker network, and similar transparency can be offered into the audience data broker network by offering a rating system. Audience data broker ratings can be calculated dynamically through the use of overlapping collection symbols. Overlapping data could be used to calculate ground truth predictions as well as verify the data provided by individual audience data brokers. This information in turn could be used to automatically rate audience data brokers. In an embodiment, a simple voting system can be used to verify the accuracy of any specific collection symbols for each broker, or the quality of the broker as a whole. The maintainers of the exchange would be responsible for publishing the voting consensus to the public, or to disbar the broker completely if necessary.

In an embodiment, no audience data broker will be able to provide ground truth data for all users. However, it might be possible to generate such data by creating data functions based on different providers and choosing the consensus opinion for each attribute. Publishers and advertisers could choose to use the consensus opinion or any individual audience data broker's collection symbols. In an embodiment, data units of “statistically significant” user data attributes could be created. Most audience data brokers often run into privacy issues not due to the data they have, but due to the data they don't know. Holes in a user profile could be significant or unique enough to be carrying sufficient information to reconstruct a unique user. Filling-in these holes using data from other user data providers could allow those providers to generate statistically significant aggregates that can be used for research purposes without sacrificing user privacy.

In one embodiment of the invention, audience broker 210 can aggregate information about publishing trends with respect to the efficacy of certain display properties used across a variety of publishers. Armed with this information about aggregate trends concerning the efficacy of certain display characteristics, and coupled with the ability to normalize display characteristics to a common vocabulary understood by all of the exchange participants, advertisers can be more effective in the marketplace.

Architecture 200 also comprises exchange 212. Exchange 212 acts as a mediator among publisher broker 204, advertiser broker 208, and audience data broker 210. Exchange 212 is the framework that allows publisher broker 204 to have its ads enriched with additional user data by audience data broker 210. In an embodiment, exchange 212 routes traffic and facilitates transactions, e.g., auctions, between publisher broker 204, advertiser broker 208, and audience data broker 210. In an embodiment, exchange 212 is a server or a set of servers. Exchange 212 creates a system in which audience data broker 210 can monetize its data and in which advertiser broker 208 can reach a larger audience of more highly targetable traffic. In an embodiment, exchange 212 provides minimum standards of conformity, ensuring that some base information about the request is provided to be used by advertiser broker 208, regardless of population data from publisher broker 204 and audience data broker 210.

To provide minimum standards of conformity, in an embodiment, exchange 212 provides collection symbols related to the category of the publisher's page, the meaningful keywords in it, as well as geo-location information extracted from the user's IP address. The base data, such as the user IP address, the URL of the publisher's page, and any other such information deemed relevant should also be provided to each advertiser broker so that the advertiser broker may attempt to extract additional information to provide value-added services to the advertisers they service. In an embodiment, exchange 212 sends all publisher broker requests that match a set of criteria defined by the advertiser broker, along with all relevant data about the request (e.g., the ask and collection symbols provided by the publisher, audience broker, and the exchange itself). In an embodiment, if the advertiser broker has any ads that it would like to have displayed and that meet the ask, it returns those ads, up to the number of ads requested, along with a CPI (cost per impression) bid on each. However, embodiments are not limited to CPI pricing, as other pricing models may be used, e.g., CPC (cost per click), CPA (cost per acquisition), CPM (cost per thousand impressions), and revenue sharing. Exchange 212 provides a call back to the winning advertiser broker(s) telling it which ads were displayed, and at what prices.

Architecture 200 also comprises users 214. For purposes of explanation only, only one user will be discussed herein. However, embodiments of the present invention are not limited to a single user, as any number of users may exist. Users 214 request a webpage from publishers 202. The webpage comprises content and advertisement space, which is filled with advertisement(s) from advertisers 206.

Using architecture 200, audience data can be provided to advertisers 206 either by enriching the publishing property with customer intelligence or by acquiring the data directly from audience data broker 210 on the basis of a licensing fee. Advertiser broker 208 can choose to pay an estimated monthly per volume amount for each attribute that their advertisers are interested in targeting. This transaction could be done off-line but would need to be registered with exchange 212 to facilitate data rerouting at request time. Advertiser broker 208 can base its bids on any targeting attributes provided by audience data broker 210. For example, advertisers 206 may place base bids either on a CPC or CPM basis and have the option to incrementally bid for any attribute values exposed to them. Advertiser broker 208 is free to pay higher rates for redundancy or higher data quality. Advertiser broker 208 may manage the risk surrounding assessing individual advertiser performance and converting all bid types to CPI for final ranking by exchange 212. In an embodiment, the pricing model is similar to the pricing models discussed above.

In an embodiment, when publishers 202 have an impression that they are willing to sell (with an optional ask), they can provide a URL and any targetable values to exchange 212. Exchange 212 passes this data and possible additional user data from audience data broker 210 to advertiser broker 208. In an embodiment, advertiser broker 208 ranks the bids of advertisers 206 using any proprietary attributes or techniques that it finds useful. For example, advertiser broker 208 could choose to run keyword extraction or categorization and use this for targeting. Advertiser broker 208 would output a CPI ranked list of advertisers (in an embodiment, the number would be equal to the number of ads requested by the publisher), where the CPI value would already be stripped of any costs used for purchasing audience data. In an embodiment, where multiple advertiser brokers exist, exchange 212 then ranks all ads across all advertiser brokers and chooses the best one (as measured by CPI). If these ads meet or exceed the publisher ask, then exchange 212 proxies a display of the ads on the publisher website.

A second-price auction can still be applied to facilitate aggressive bidding. Publishers 202 can get paid on a CPI basis. Ad impressions are logged to be used for traffic volume calculations used for audience data licensing. In an embodiment, exchange 212 may be used to gate user information originating from publishers 202. Publishers 202 can choose to enrich their property with user data and share this information only with selected advertiser brokers.

To facilitate participants of all types to become part of architecture 200, it may be desirable to establish a pricing model that is extremely flexible, yet at the same time does not change the industry paradigm so greatly as to create confusion that would prevent potential participants from joining architecture 200. Advertisers are already accustomed to both CPC and CPM pricing, with a small but increasing market for CPA (cost per acquisition) pricing. Publishers tend to prefer CPM pricing, and the larger, more complex publishers sell traffic broken down by user demographics and in other ways. Smaller publishers generally have to accept what they can get, which often results in CPC or CPA pricing. Profile owners, such as audience data brokers, have not typically been able to capitalize on their data, and when they have, have done so in flat transactions for aggregate data.

To support the flexibility of all of these pricing models, and even to allow for others in the future, in an embodiment, exchange 212 is based on a CPI model between publisher broker 204 and advertiser broker 208, where, on each request, publisher broker 204 will set a minimum ask, i.e., reserve price, for their available ad space, and advertiser broker 208 will place a bid on the right to have their ads displayed on this request. As discussed above, embodiments are not limited to CPI pricing only. Exchange 212 will take a small portion of the revenue flowing through it to support its operations, which can either be implemented via incrementing the publisher ask by some percentage, or by making agreements with publishers 202 that some percentage of the revenue generated from their traffic will be held back.

Because publishers 202 are concerned with user satisfaction, they would prefer to have some control over the relevancy of the ads placed on their site. Click-through rate is considered a good measure of relevance and therefore many publishers might want minimum click-through guarantees on the ads. Exchange 212 allows publishers 202 to optionally specify a minimum click-through rate that is acceptable. Exchange 212 monitors advertiser broker 208 to make sure that if it wins these types of asks, then it is meeting the performance guarantees. In an embodiment, if an advertiser broker consistently provides low click-through rates for publisher asks that require a minimum, exchange 212 may take punitive measures such as suspension from the system.

Advertiser broker 208 is responsible for converting any externally facing pricing models it allows into the CPI bid on each request. For example, a simple CPC to CPI conversion would be to multiply the per click bid of each ad by the expected click through rate of the ad for the conditions present. Similarly, to convert a CPA bid to CPI, advertiser broker 208 could multiply the conversion rate by the per conversion bid of the advertiser. The more information available in each request, the better job advertiser broker 208 can potentially do in predicting the probability of a click or a conversion. Since it is expected that advertiser broker 208 will therefore desire additional information along with each request to help it predict what those probabilities are, as well as to allow the advertiser to express a preference for one or another of those attribute values by bidding differently, they will want to have information from audience data broker 210 at request time. The pricing model between audience data broker 210 and advertiser broker 208 will be a market, where audience data broker 210 sets minimum guarantee asks, as well as CPM pricing rates. In an embodiment, advertiser broker 208, if it wishes to use audience data broker 210's information, will agree to pay the greater of the guarantee amount or the CPM rate for the number of ad impression auctions that it wins. Exchange 212 is necessary to this transaction so as to track the number of ad impression auctions advertiser broker 208 wins, as well as to query for an attach audience data broker 210's user information to the request sent to advertiser broker 208.

The entity hosting exchange 212 has access to all data sources, giving it the power to make partial decisions. To alleviate the concern that exchange 212 will not be impartial both as hosting body and as a direct participant, in an embodiment, transparency will be built into exchange 212. In that embodiment, exchange 212 does not have a way to identify brokers of any kind. Also, in that embodiment, advertiser auction algorithms and advertiser to publisher and audience data broker matching algorithms are standardized and transparent to all exchange participants. In an embodiment, no user identifiable information is sent to advertisers 206 until the user performs an action. Exchange 212 passes advertiser broker 208 only the attribute values. Advertisers 206 do not see the user identifier. At click-time, however, it is still possible for an advertiser to establish a user identifier and associate the bidding profile with that user. By participating in architecture 200, audience data broker 210 is explicitly sharing its information with advertiser broker 208. Although some leakage is inevitable whenever targeting is permitted (e.g., if a user is targeted and clicks on an ad, the advertiser can correlate and store the targeting attributes for that user), providing audience data from every ask to advertiser broker 208 for bidding purposes exacerbates the problem. However, this can be addressed by centralizing the auction system at the exchange level by requiring that advertiser broker 208 specifies a value function that is evaluated for each ask on exchange 212. For example, exchange 212 could require a linear value function, and advertisers 206 would specify a base bid and a bid increment for each attribute value. Exchange 212 would control the instantiation of the audience data, thus not leaking any to advertiser broker 208.

In one example, Expedia as an advertiser has an ad for “cheap vacations in Bali.” Expedia chooses the keyword “Bali vacations.” Business intelligence suggests that the best way to target vacation ads is around users who have a history of purchasing vacations, users who recently have purchased books on vacations and users who perform searches related to travel. Expedia decides to license user information from Amazon, MSNSearch, and Orbitz. Expedia agrees to pay Amazon 1 cent for using their user information for each ad impression. Similarly, Expedia agrees to pay 1 cent to MSNSearch and 3 cents to Orbitz.

For the “cheap Bali vacations” ad, Expedia creates a targeting profile for users who: “bought a book on Bali in the last month,” “Have traveled to a tropical location in the last two years,” “Have household income between $30,000 and $60,000,” “Have been searching for vacation deals,” and “Have ever clicked on ads.” Expedia places a 20 cent base bid. To express their bidding preference, they also place a 5 cent incremental bid for the first attribute, a 10 cent incremental bid for the second attribute, a 2 cent incremental bid for the third attribute, 1 cent incremental bid for the fourth attribute, and a 2 cent incremental bid for the fifth attribute to express their bidding preference. Additionally, exchange 212 will log all views where user data was used to enrich targeting and help audience data broker 210 enforce the licensing fees. Borders as a publisher has a user requesting the page on the “Lonely Planet Guide to Indonesia” and they would like to show ads on that page. They call exchange 212 with the page URL and information about the user: “Bought four travel books in the last month,” “Bought a book on Bali in the last month,” and “Has clicked on ads before.”

Given the URL, exchange 212 extracts keywords (“Bali vacations,” “Indonesia travel,” “exotic vacations,” “beach vacations”), categories (“travel,” “vacations”) and proxied user data information (coming from the licenses with audience data broker 210), and sends this information to each advertiser broker. Each advertiser runs an auction for the impression. The advertiser broker can choose to ask for aggregate bids from advertisers and subtract the audience data broker licensing fees at the time of the impression. For example, Expedia might place an aggregate bid of 24 cents, and after subtracting the licensing fees, their base bid would be equal to 20 cents. Expedia's advertiser broker needs first to subtract all incremental bids and to assign credit to the publisher or audience data broker as appropriate. For example, Expedia's 5 cent incremental bid for “bought a book on Bali in the last month” and their 2 cent incremental bid for “Have ever clicked on ads” will be assigned to the publisher. The value for “Have traveled to a tropical location in the last two years” attribute is provided by Orbitz so the 10 cent incremental bit would be assigned to them. Neither the publisher, nor the audience data brokers were able to assess the household income of the user so this incremental bid is not used. The 1 cent incremental bid for the search user patterns will be credited to MSNSearch. After the appropriate credit distribution the advertiser broker would assign a publisher value bid (the base bid+any incremental publisher bids) to each advertiser. In case of Expedia publisher value bid would be equal to 27 cents. Given that Expedia's bid is CPC based, the advertiser broker needs to convert it to a CPI one before running an auction and selecting the best ads to send to the exchange. Expedia's advertiser broker knows that this specific ad is likely to get a 10% CTR, and thus for ranking purposes, Expedia is assigned a 2.7 cent CPI bid. If Expedia wins within its advertiser broker, its ad will be sent for global ranking to the exchange. If Expedia wins the global auction then their advertiser broker is charged 2.7 cents for displaying the Expedia ad. Expedia's ad gets served on Border's page. The user clicks on the ad. The user buys a two-week vacation to Bali.

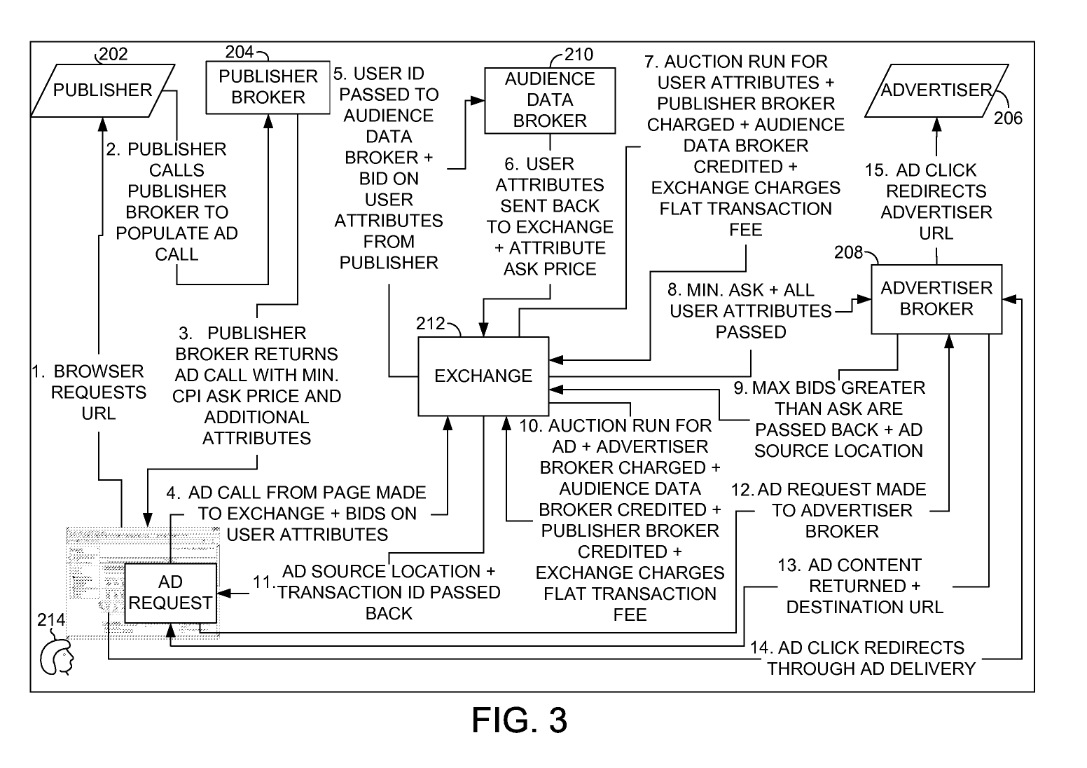

FIG. 3 illustrates one example of the flow of data within architecture 200, according to embodiments of the present invention. Referring to FIG. 3, user 214 opens a browser and requests a URL of a webpage from publisher 202 (1). In an embodiment, the webpage has some advertisement space available, which publisher 202 desires to sell to an advertiser. Publisher 202 calls publisher broker 204 to populate the ad call (2). Publisher broker 204 returns the ad call with a minimum CPI ask price and additional attributes (as discussed in greater detail above) (3). The ad call is made to exchange 212 along with bids on user attributes and a user identifier (4). Exchange 212 passes the user identifier and the bid on attributes to audience data broker 210 (5). In an embodiment, audience data broker identifiers are stored on the user-side and are sent with the ad call to exchange 212 so that exchange 212 can identify which audience data broker(s) may have information about the user. Audience data broker 210 looks up the user identifier and responds with the corresponding attributes along with an attribute ask price (6). In an embodiment, exchange 212 runs an auction for the user attributes, charges publisher broker 204, credits audience data broker 210, and holds back a flat transaction fee (7). Exchange 212 passes a minimum ask plus all user attributes to advertiser broker 208 (8). Advertiser broker 208 responds with all of the bids that are greater than the ask, along with the ad source location (9). In an embodiment, exchange 212 runs an auction for the ad, charges advertiser broker 208, credits audience data broker 210 and publisher broker 204, and holds back a flat transaction fee (10). Exchange 212 passes the ad source location and transaction identifier back (11). An ad request is made to advertiser broker 208 (12), which responds with the ad content and a destination URL (13). If user 214 clicks on the ad, the user is redirected by advertiser broker 208 (14) to advertiser 206 (15). The above example illustrates just one embodiment of the present invention. Other embodiments may not involve the same operations or conduct them in the same order. Specifically, other examples may not supplement with data from audience data broker 210. Other examples may not rely on auctions to set prices, instead relying on a firm ask that can be accepted or declined.

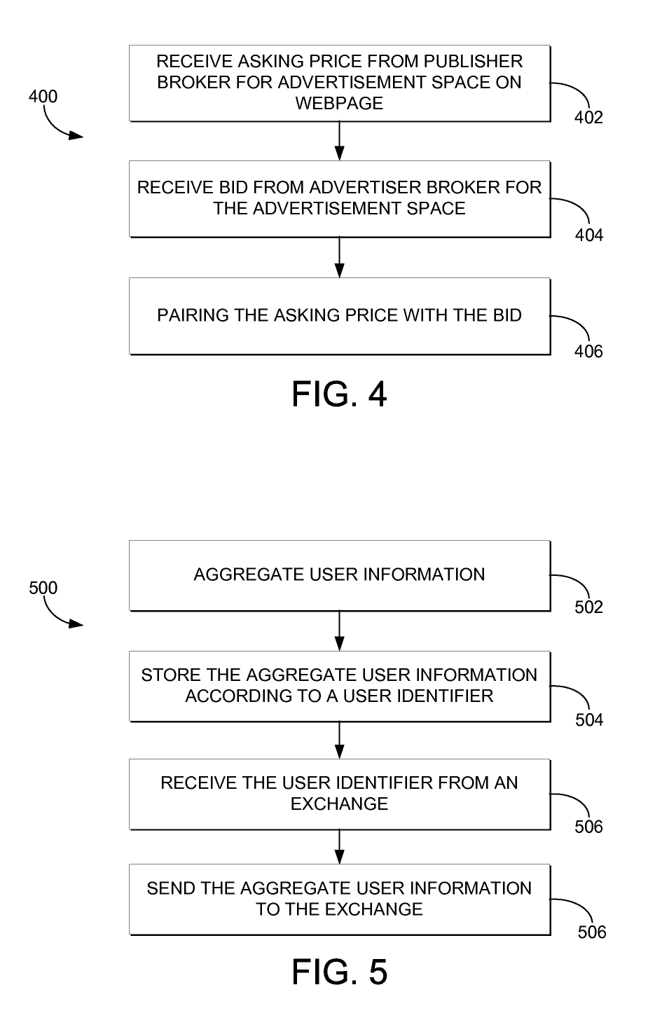

FIG. 4 illustrates a flowchart of the operation of an exchange, according to embodiments of the present invention. Referring to FIG. 4, method 400 begins with the receipt of an ask from a publisher broker for advertisement space on a webpage (402). A bid is received from an advertiser broker for the advertisement space (404). In an embodiment, bids are received from many different advertiser brokers. The ask is paired with one of the bids (406) and the advertisement space on the webpage is awarded to the winning bidder. As discussed in greater detail above, other information such as user attributes may be attached to the ask, and quality of the bidding advertisers may be examined prior to the advertisement space being awarded.

FIG. 5 illustrates a flowchart of the operation of an audience data broker, according to embodiments of the present invention. Referring to FIG. 5, method 500 begins with the aggregation of user information (502). The aggregate user information is stored according to a user identifier (504). When the user identifier is received from an exchange (506), the aggregate user information corresponding to that user identifier is sent to the exchange (508). In an embodiment, the audience data broker may set a cookie on the user computer to identify itself as having information about that user. When the exchange reads that cookie, it knows which audience data brokers to query for information about the user.

Accordingly, in non-limiting embodiments, the invention includes a system to facilitate trading of advertising by having a publisher broker to represent publisher(s) that determines an ask for an advertisement space on the publisher(s)' webpages. An advertiser broker also represents advertiser(s) and manages an advertiser(s)' bid for the advertisement space. The exchange of the invention then facilitates transactions for advertisement space between the publisher broker and the advertiser broker.

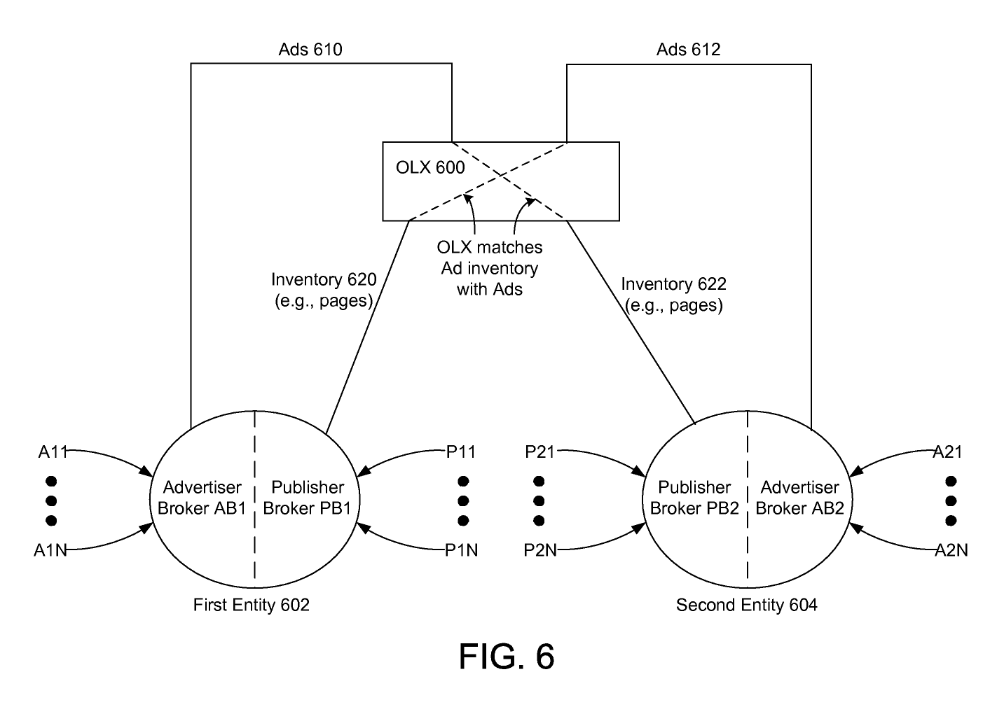

The invention thus can operate in a system that enables broad liquidity over distributed advertising markets, such as the above-described advertising exchange systems. FIG. 6 illustrates a conceptual block diagram of an on-line advertising exchange 600 provided in accordance with the invention. As shown, a first entity 602 and a second entity 604 are subscribers to the services of exchange 600. First entity 602 may have an advertiser broker AB1 for brokering advertisements 610 from a variety of sources A11 thru A1N and a publisher broker PB1 for brokering inventory 620 from a variety of publishers P11 thru P1N. A goal of ad broker AB1 is to find inventory for existing advertisements. A goal of publisher broker PB1 is to represent publishers, i.e., to help obtain revenue for their inventory (e.g., pages). Similarly, second entity 604 may have an advertiser broker AB2 for brokering advertisements 612 from a variety of sources A21 thru A2N and a publisher broker PB2 for brokering inventory 622 from a variety of publishers P21 thru P2N.

In accordance with the invention, by providing ads 610 and 612 to OLX 600 according to a first communications layer, and by providing inventory 620 and 622 to OLX 600 according to an independent communications layer, OLX 600 can efficiently match advertisements to available inventory with greater simultaneous knowledge of multiple advertising networks.

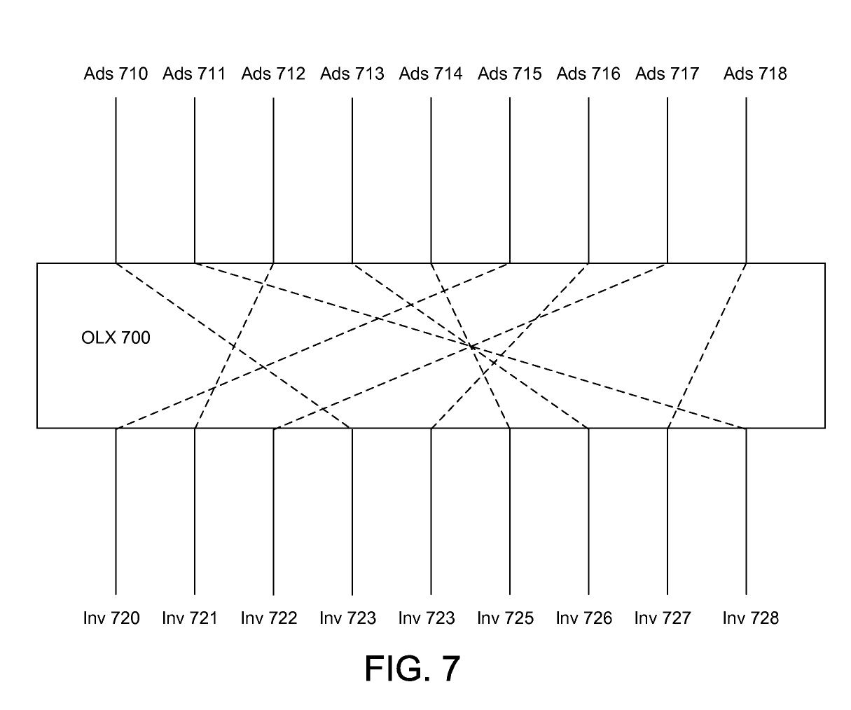

For instance, first entity 602 might be Microsoft's MSN Web site, and second entity 604 might be Yahoo's portal Web site. For simplicity, FIG. 6 illustrates only two entities, but advantageously, the invention can also be scaled to accommodate any number of advertising networks, e.g., eBay, Amazon, Google, etc. This is illustrated in FIG. 7 showing an OLX 700 that accommodates a wide range of advertising 710, 711, 712, 713, 714, 715, 716, 717, 718, etc. from a wide range of parties, and also accommodates a wide range of inventory 720, 721, 722, 723, 724, 725, 726, 727, 728, etc. from a wide range of parties. OLX 700 then makes the best assessment of how to match advertising content with inventory according to a variety of policies (e.g., maximizing ad revenue, maximizing quality of advertising, maximizing conversion rate, etc.). IN accordance with embodiments of the invention, OLX 700 then makes the best assessment of how to match advertising content with inventory according to a variety of policies having to do with the display properties for a given advertising medium. While various non-limiting embodiments of the invention are described in the context of two parties herein, this is for ease of conceptual presentation. It can be appreciated that the invention can be provided for any arbitrary number of advertising entities wishing to join the exchange 700.

Having thus described an exemplary advertising exchange environment, various non-limiting embodiments of the specification, normalization and tracking of display properties for participants of an advertising exchange or advertising framework in accordance with the invention are now presented in more detail below.

### Specifying, Normalizing and Tracking Participant Display Properties

As mentioned, the invention enables each participant to a multi-party advertising exchange to specify one or more display properties that are translated to a common vocabulary for describing the display properties within the exchange. The disparate display properties of multiple participants can thus be normalized within the advertising exchange by converting the display properties to the common vocabulary enabling the comparison or translation of a first set of display properties to a second set of display properties in quantifiable terms.

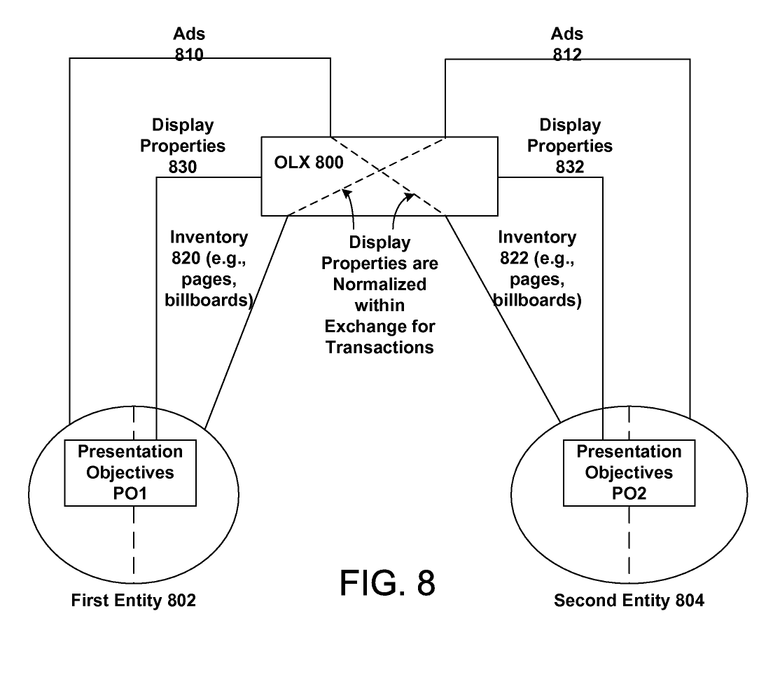

FIG. 8 illustrates an exemplary non-limiting embodiment of the invention that provides the ability to balance local party objectives with respect to presentation of advertising in advertising transactions with remote party objectives with respect to their presentation goals for an advertising transaction. Each participant is provided with the ability to create and modify their presentation objectives for input to the exchange 800. First entity 802 thus has a set of presentation objectives PO1 and second entity 804 has a set of presentation objectives PO2, which allow the entities 802 and 804 to fine tune their preferences with respect to display properties of advertising 810, 812 and inventory 820, 822 in the exchange 800 in accordance with the invention.

Receiving presentation objectives PO1 and presentation objectives PO2, exchange 800 automatically operates to normalize PO1 and PO2 to a common vocabulary within exchange 800 and helps to facilitate matches between advertisers and publisher inventory based on a comparison of presentation objectives. This operates to balance the local objectives with the remote objectives based on pre-specified presentation objectives, requirements or criteria so that all parties are satisfied with the quality of the presentation of advertising resulting from transactions.

The exchange 800 thus, in effect, helps to place a premium on publisher inventory when specific display requirements are met by the publisher inventory, but where such publisher inventory is of limited supply. Similarly, the exchange 800 in effect taxes or penalizes publisher inventory that meets limited demand by advertiser due to the low quality of the publisher's presentation space. The invention thus provides a taxation method to balance presentation objectives of buyers with presentation objectives of sellers in the exchange.

For instance, a concrete example of the operation of such a taxation method would be if Yahoo, as first entity 802 with publisher space, says, “we don't want our ads published in pop up advertising publishing inventory (of generally low quality).” By defining this presentation objective in objectives PO1, this information is taken into account by exchange 800 so that the exchange 800 will not make matches to publisher inventory that meets a definition for pop up advertising inventory. In this respect, if a lot of advertisers do not prefer pop up advertising inventory, a “bad quality” tax will be in effect imposed on publishers having “pop up” inventory. Conceptually, each party thus has “knobs” to fine tune the way its inventory or advertisements are handled by exchange 800 from a presentation standpoint, which in turn is represented according to a common vocabulary for display properties within the exchange 800, and from which matches are facilitated based on supply and demand for inventory, taking into a comparison of presentation objectives of the participants.

As mentioned, in exemplary, non-limiting embodiments, the distributed framework for online advertising of the invention enables the specification of personal or private display properties, i.e., each party can specify respective maximization functions for various display properties for transactions in the advertising exchange.

Since each party has unique business goals and objectives, a wide variety of presentation objectives may be toggled, or modified in accordance with the invention to specify party display properties on a per party basis. For instance, the position of advertising on a publisher's inventory, the timing and duration of the display of advertising on the publisher's inventory, the type or kind of advertising as known in the industry, e.g., pop up, pop under, pop over (e.g., Flash media), banner ads, right rail (e.g., for sponsor ads), Web search display, bottom ads (e.g., South position), Toast, Top Left, Top Right, digital billboard, Blog ad space (e.g., ads for MSN's MySpace pages), or any other kind of category of advertising inventory that is available via publisher brokers in an exchange, the size of the publishing inventory, the shape of the publishing inventory, the amount of other display elements in proximity to the advertising (i.e., a measure of clutter), the speed of display of the advertising (i.e., page upload speed), the quality and size of the typefont on the publisher's inventory, or any other parameter that specifies an aspect relating to the display properties for advertisements displayed at a publisher's inventory.

Once each party has specified a complete set of display properties that maps to the goals and objectives of the party with respect to advertising, this information is received by the exchange. Since initially, different parties' display properties may be specified according to different vocabularies, the exchange operates to normalize all of the display properties of the different parties into a common vocabulary. For instance, an ad broker might specify an advertising requirement by an advertiser concerning the “South Position of a Web page,” whereas a pub broker may specify publisher inventory of “Bottom Web page Banner” with respect to advertising. In such a case, the invention operates to normalize the different specifications to a common standard for comparison so that it can be determined whether the publisher's inventory will satisfy the requirements of the advertiser. In this case, publisher inventory of “Bottom Web page Banner” will map to the requirement of “South Position” in terms of the common vocabulary of the invention, and will also map to a requirement of “No Top, Left or Right Positioning” by another advertiser.

As mentioned, there are a variety of display properties and parameters that can be defined or specified as a requirement by a party in accordance with the invention. Any party can specify a set of display properties for transactions in the exchange, and based on known mappings between different ways of specifying presentation for advertising, display properties across different parties can be normalized, and thus compared.

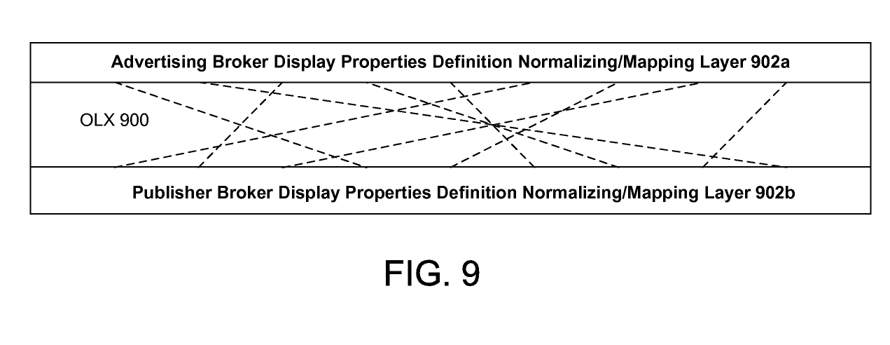

In this regard, presentation objectives of a participant can include any arbitrary function that is based on a variable of advertising pertaining to the display of advertising for any kind of advertising product. This is illustrated conceptually by exchange 900 depicted in FIG. 9. As shown, for display properties defined by advertising brokers for their advertising entities, a mapping/normalizing layer is shown as a first layer 902a before matching content takes place in order to normalize display properties defined across parties for transactions in the exchange. In addition, another layer 902b normalizes display properties received from publisher brokers for the inventory of publishers represented in the exchange 900. Once normalization occurs in layers 902a and 902b, to compensate for the individual presentation preferences of the participants, exchange 900 operates as described elsewhere herein to match supply of advertising inventory to demand by advertisers for the inventory based on display properties specified by the parties. In one embodiment, the normalization process is made blind to the identities of the parties' involved in order to ensure a fair and objective normalization of display properties.

In addition, in order to specify display properties, the invention provides tools that allow entities participating in the exchange to explicitly state their preferences for display properties for their advertising, or their definitions of display properties for publishing inventory.

In other embodiments, participants can explicitly, or implicitly, specify a target set of display properties to the exchange, whereby based on the target set, the exchange automatically tailors a set of advertising transactions with respect to display properties that optimize for one or more objectives of the participant. This enables participants to specify, for instance, that they prefer “low-clutter” publishing inventory, automatically triggering the exchange to display advertising inventory with a “low-clutter” filter over their display properties. Alternatively, an advertiser may actually wish for “high-clutter” space for different reasons.

For instance, an advertiser participant such as Nike, might wish to advertise on publisher sites that have a high quality of display properties. Thus, the advertiser participant may specify, as part of a bid for publishing inventory, that the advertiser participant only wants publishing sites with display properties that cater best to sports. For instance, the advertiser participant may specify as part of a keyword bid for “golf” that the participant wants publishing inventory having display properties that cater best to golf enthusiasts. Given the generally affluent and highly targeted nature of golf enthusiasts, there may very well be a particular set of display characteristics.

In other exemplary, non-limiting embodiments of the invention, an advertiser can specify, e.g., via filling out a form, a set of properties for an advertising transaction of interest to the advertiser. Based on the set of properties specified for the advertising transaction, the exchange can auto-generate the “best” type of ad for one or more objectives specified by the advertiser. For example, in the keyword context, the advertiser would fill out a set of advertising properties for the term “flowers” based on one or more local objectives of the advertiser and as a result, the exchange automatically generates an advertisement and informs the advertiser of the types of display properties that perform best under the given objectives specified by the advertiser.

For instance, the exchange would inform the advertiser that, for the advertiser's goals and the keyword “flowers,” that “textual ad, right rail and above the fold” provides the maximum ROI. The exchange may then automatically display a set of advertising inventory for purchase within the exchange that satisfy the best display properties for the advertiser. In the example, for instance, the exchange can generate a set of textual ads for the advertiser and can display a corresponding set of publishing inventory satisfying the display properties that maximize the goals of the advertiser. As a result, by merely specifying a set of goals for a type of advertising, e.g., keyword advertising, the invention automatically optimizes the display properties for the given goals of the participant in the exchange.

In this regard, confirmed by the variety mentioned above, the number of factors that an exchange participant can vary with the tools of the present invention to personalize display properties for advertising are virtually limitless. Also, the factors can be tailored to advertising segments, i.e., banner ads can have different factors for presentation than keywords, which have different factors for presentation than pop-up ads, and so on.

Furthermore, rather than require an explicit mathematically defined set of display properties, the tools of the invention optionally express display properties factors in terms of business goals, e.g., maximizing revenue, preserving brand name, broadest advertising exposure, most socially responsible advertising exposure, most demographically targeted advertising exposure, policies based on clickthrough/impression/conversion/acquisition probabilities, and the like. Conversion tracking as a function of display properties described in more detail below enables such definition in terms of business goals since past performance of certain subsets of display properties can be mapped to functions representing such business goals. For instance, conversion data can be mined to determine the best set of display circumstances for maximizing revenue, for achieving a demographically targeted effect, etc.

As mentioned above, in further embodiments of the invention, conversion tracking is enabled for the exchange of the invention based on display properties to provide a more solid understanding of conversion rate for advertising because the information is provided across advertising networks and across different parties. An audience broker can keep track of such conversion information and/or such information can be recorded within an advertising exchange. In essence, it is known that by increasing one's conversion rate for advertising, a marketer can lower the cost per acquisition without changing the cost paid for traffic. Even a small increase in conversion rate can have a dramatic profit impact, and so it is desirable to find publishing space with presentation characteristics having a high expected conversion rate.

Also, with conversion tracking provided in the distributed framework for online advertising in accordance with the invention, pricing can be made more accurate because conversion information about how different display characteristics perform is available across a large number of parties, averaging out individual transactional biases with respect to display properties within an advertising network. Moreover, individuals can better understand how the same advertisement performs under different presentation characteristics to better understand the best circumstances for display of a particular advertisement type.

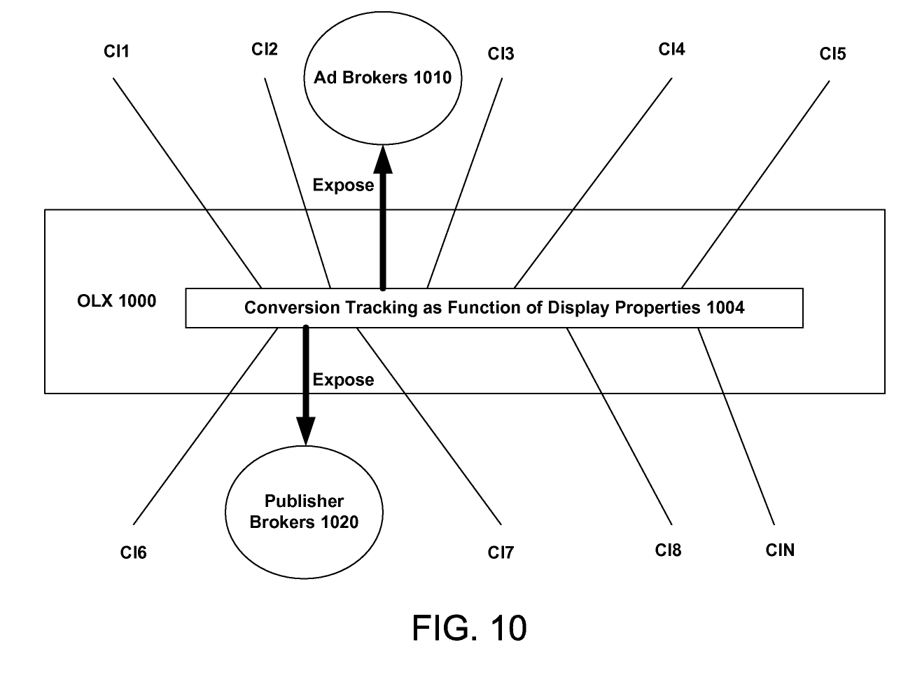

As mentioned, due to the federated nature of the exchange of the invention, conversion tracking across different advertising networks can be achieved for a more holistic view of conversion rates for different advertising products under different advertising conditions. As shown by the online advertising exchange (OLX) 1000 of FIG. 10, the invention thus includes the ability to aggregate conversion rate information from disparate sources, e.g., any of conversion information C11, C12, C13, C14, C15, C16, C17, C18, . . . , CIN. By collecting conversion rate information via a common tracking component 1004, a real-time accurate view is enabled over conversion rates across the exchange. Then, the conversion information can be exposed to ad brokers 1010 or publisher brokers 1020 in a format that relates the conversion information to corresponding display properties.

In one embodiment, a modifier is specified as a discount rate, i.e., if a publisher is known to have a bad conversion rate for certain display properties for its publishing inventory, the publisher's inventory can be discounted in a way that is proportional to the modifier. As the publisher's conversion rate becomes better and better, the modifier improves for the publisher, i.e., the exchange dynamically prices that publisher's space at a higher premium to recognize the improvement in quality of display properties of the inventory. Similarly, if a publisher's quality of presentation begins to fall, the exchange of the invention will dynamically lower the price for that publisher's inventory.

Initially, not a lot will be known about the conversion rate of an unknown publisher, however, by analyzing the display properties of the unknown publisher's inventory, past history of conversion information based on display characteristics can be used to predict the quality of performance of advertisements. In this respect, the exchange of the invention can operate as an independent referral or validating source for quality advertising spaces by pricing inventory that reveals display characteristics that yield high conversion rates at a standard rate (e.g., 20%) higher than inventory with no display characteristics specified.

Similarly, on the advertising side, an advertiser can be penalized by applying the modifier as a discount rate for having low quality advertising due to display characteristics of the advertising relative to other advertisers. For instance, the amount of “flicker” or “flashing” in advertisements or other rude and annoying distractions to the eye can be monitored, the size of the advertisement, the duration, the ability to close the advertisement prior to completion, speed of upload, i.e., any display characteristic that could affect conversion rate for the advertising, and that a publisher might set a function for as a presentation objective for advertising displayed in its publishing inventory.

For another concrete example of how this might apply, as any casual browser of the Internet has observed, mortgage brokers generate a lot of advertisements across a lot of different advertising spaces. As a result, the user experience around mortgage advertising is low, and the ads tend to be of poor quality, of low relevance and annoy users of the publisher's web site as a result. Accordingly, the exchange of the invention may apply a discount rate to mortgage advertisers that is commensurate with the low presentation quality of their ads.

In addition, the quality of the advertiser broker can be taken into account as well. By applying a discount function, such as F(quality of presentation, quality of advertiser broker), the quality of the advertiser and/or broker can be taken into account when considering how to price a particular inventory given a candidate advertisement for match. In this respect, much like the Page rank algorithm rates Web sites in terms of endorsement, any proxy for quality of presentation of an advertiser can also be used when the exchange of the invention operates to match potential buyers and sellers of advertising space based on desired display characteristics expressed by the parties.

In one non-limiting implementation, a non-linear curve is adopted to weight conversion rate based on presentation characteristics as more important when matching advertisements to publishers by the exchange of the invention. While conversion rate has historically been used as a linear factor in pricing an advertising product, applying a non-linear curve based on clickthrough rate can serve as a corrective market force, which penalizes the low quality “spam” advertisers with poor presentation characteristics, or conversely, reward advertisers that historically present advertisements with high quality presentation characteristics.

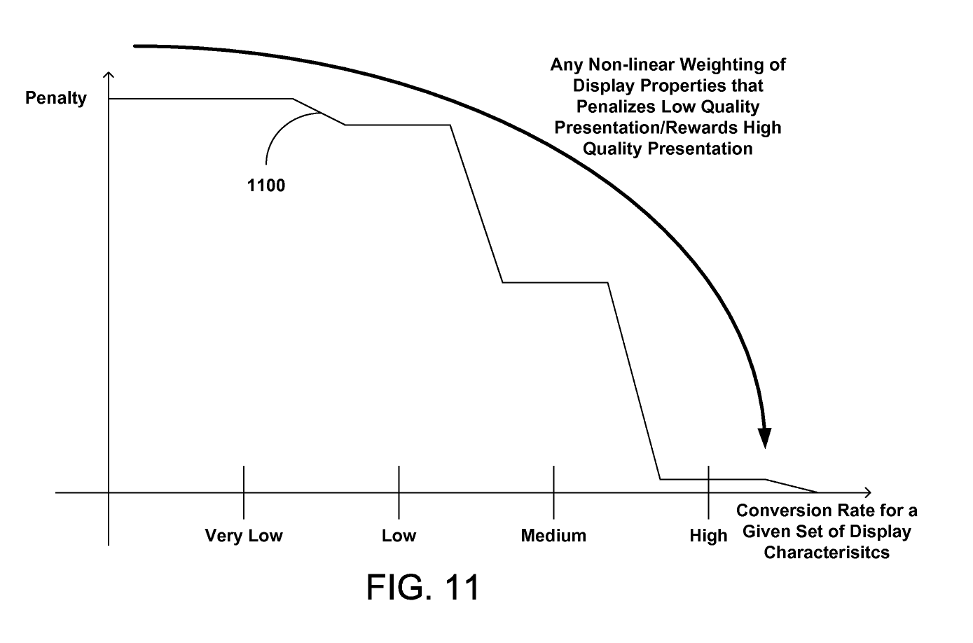

To elaborate, FIG. 11 shows an exemplary, non-limiting curve 1100 representing conversion rate for a given set of display characteristics for an advertising product on the X-axis varying non-linearly with cost penalty on the Y-axis. Whatever metric for presentation quality is selected, e.g., conversion rate values or ranges, advertisers that have a very low or low presentation quality score are assigned a high cost penalty. On the other hand, advertisers with demonstrated presentation quality are assigned no or a very low cost penalty, or even an explicit positive reward (i.e., a cost discount rather than no cost penalty). In the middle, advertisers with medium quality are assigned some pre-specified cost penalty, but vastly reduced relative to the cost penalties of the very low or low quality advertisers. In this regard, any non-linear weighting scheme can be applied based on the quality of the advertiser corresponding to a given set of display characteristics in accordance with the invention, and as described earlier, such weighting scheme can be part of an entity's locally defined preferences for display properties since some publishers may be more averse to hosting spam advertisers than others.

In this regard, any non-linear weighting scheme can be applied based on a proxy for conversion rate for publishers or advertisers in accordance with the exchange of the invention, and as described earlier, such weighting scheme can be specified as part of an entity's personal display properties. Some advertisers, for instance, may wish to specify that they are particularly averse to (i.e., wish to penalize in a non-linear manner) advertising in spaces with low or very low presentation quality, or alternatively, wish to only advertise in spaces with high presentation quality, unless the price is imminently inexpensive. Such penalties on publisher inventory with low conversion rates operates as a lever on the free market forces that normally would apply to matching advertisements with inventory by the exchange of the invention. As a result, publishers have an additional incentive to keep content presentation quality high in order to help avoid low conversion for ads coupled to the content, having a beneficial effect on the overall user experience of online advertising as encountered by users as well.

In other exemplary non-limiting embodiments of the invention, temporal aspects or other changes over time to the display characteristics of the presentation of advertisements by publishers are automatically tracked in accordance with the conversion tracking based on display characteristics in accordance with the invention. For instance, display property curves can be applied over time to inventory so that certain inventory is priced properly in accordance with temporal events that affect the display properties of presenting a particular advertisement. For instance, a switch from a right rail position to a bottom position on a Web page might result in a marked drop in conversion rate for a particular advertisement. In such case, the invention can operate to automatically reprice the display of the advertisement in accordance with the lower conversion rate associated with the bottom position. Accordingly, in various non-limiting embodiments, the exchange of the invention operates to normalize pricing for inventory based on temporal variation of display characteristics that affect conversion rate for the advertising.

In other exemplary, non-limiting embodiments of the invention, the exchange of the invention takes forecasting information as input when normalizing advertising currency across the available ads and inventory. Forecasting information includes any reliable metric for predicting a future successful set of display characteristics as different advertising models are born and fade on the fast moving Internet, and includes, but is not limited to, metrics for monitoring inventory supply and demand curves relative to display characteristics. In addition, as mentioned earlier, the exchange of the invention operates to normalize display definitions and requirements as between a whole host of publisher brokers and advertiser brokers, and in doing so, creates a market for the exchange of advertising products according to different display sub-categories, including futures market pricing for those sub-categories. Forecasting information can thus be applied by the exchange of the invention when setting a price for online advertising futures for any of the sub-categories as well.

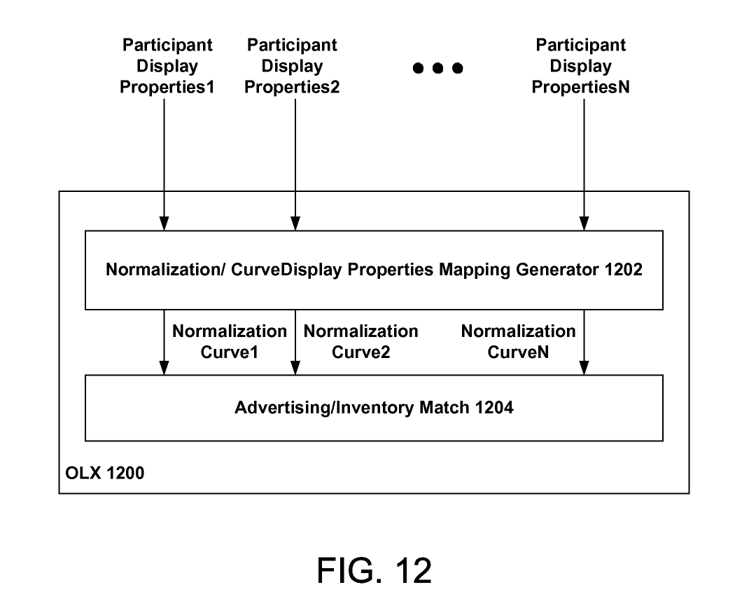

Since each publisher broker has different rules that apply to display properties for advertising or inventory, in various non-limiting embodiments, the exchange of the invention generates normalization curves that apply across multiple participants. In an exemplary embodiment, as shown in FIG. 12, Participant Display Properties1, Participant Display Properties2, . . . , Participant Display PropertiesN are submitted, which are received by normalization curve generator 1202 of OLX 1200. In this respect, normalization curve generator 1202 shields the advertising/inventory match process 1205 for determining how different display property definitions interrelate.

In the present embodiment, normalization curve generator 1202 generates normalization curves Curve1, Curve2, . . . , CurveN, which are then used by advertising/inventory match 1204 to achieve a global exchange among all of its participants while maintaining transactional balance based on participant preferences with respect to display properties. In another embodiment, since normalization curves are indirect mathematical expressions of a broker's pricing and transactional preferences, the invention operates to hide the biases expressed by any particular broker's display properties from the advertising/inventory match process 1204, i.e., the identities of the participants are unknown from the perspective of OLX 1200.

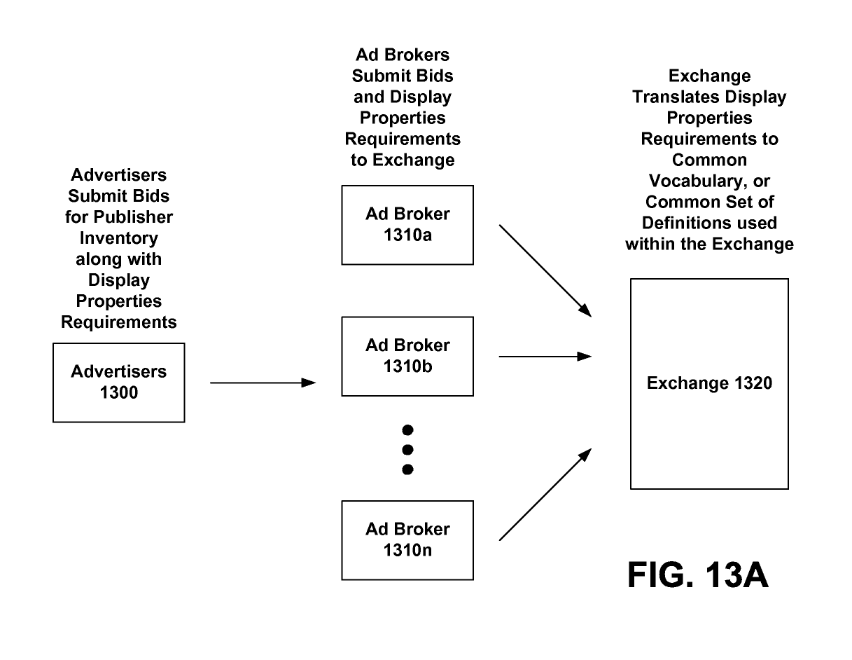

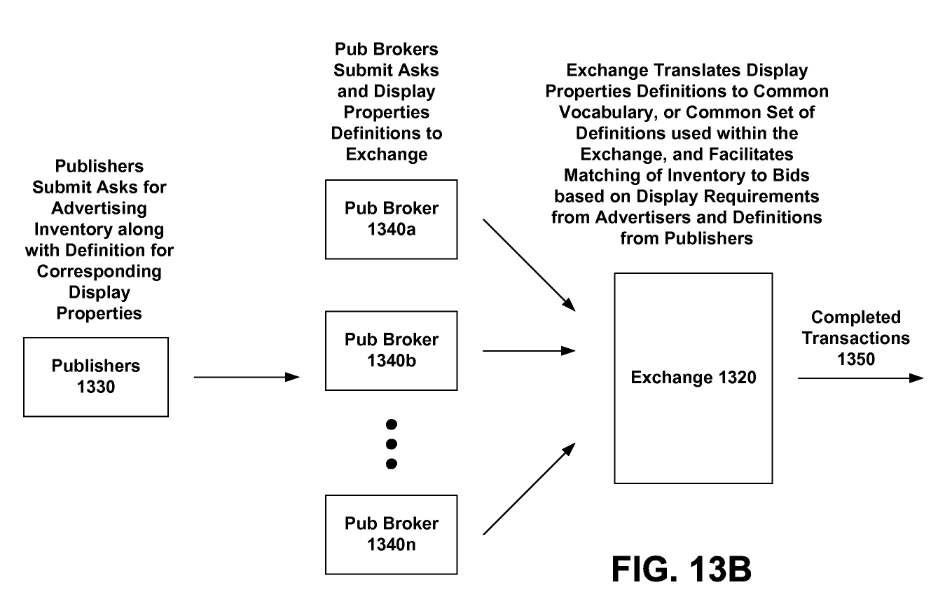

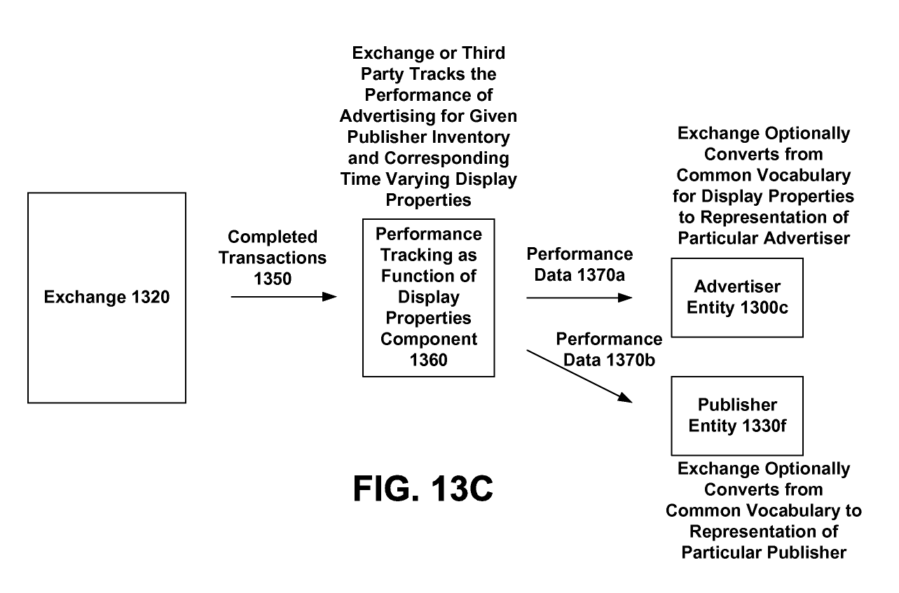

FIGS. 13A, 13B and 13C illustrate exemplary normalization of display properties in accordance with the invention as between advertisers, advertising brokers, publishers and their brokers, the exchange that facilitates the normalization of disparate preferences, and the automatic tracking of conversion information. In accordance with the invention, any display properties can be defined on a per participant basis that maps back to a set of business objectives by the participants of an exchange, and by translating the display properties to a common nomenclature for display properties within the exchange, which can be implemented in a myriad of ways, a common ground is defined so that the advertising exchange is grounded end to end by an expectation of display properties for advertising by all parties to an advertising transaction. The standardized vocabulary enables each party to the exchange to compare display property requirements with availably display property inventory.

For instance, as shown in FIG. 13A, advertisers submit bids for publisher inventory to ad brokers 1310a, 1310b, . . . , 1310n, including preferences or requirements for display properties for the publisher inventory in the exchange 1329. Ad brokers 1310a, 1310b, . . . , 1310n choose to broker the ad along with the requirements for display properties. Then, for further transaction in the exchange, the display properties of the bids for publishing inventory are transformed to a common vocabulary in exchange 1320 that can be used in connection with transactions with publishers selling their inventory.

As described above in connection with FIG. 12, the preferences for display properties of publishers and publisher brokers can also be normalized to a common vocabulary in exchange 1320 so that apples to apples comparisons can be made when transacting. This is illustrated in FIG. 13B where publishers 1330 submit asks for advertising to pub brokers 1340a, 1340b, . . . , 1340n along with a definition describing the way that the advertising will be displayed. The pub brokers 1340a, 1340b, . . . , 1340n submit the asks and display properties definitions to the exchange 1320, which translates the display properties definitions to the common vocabulary, e.g., a common set of categories or definitions used with the exchange 1320. The exchange 1320 also facilitates matching of asks to bids based on display requirements from advertisers 1300 and the definitions from the publishers 1330. This results in completed transactions 1350 that are matched based on display properties.

FIG. 13C illustrates how the common vocabulary of the exchange 1320 can be used after transactions 1350 are completed. In accordance with another exemplary, non-limiting aspect of the invention, conversion tracking by a performance tracking component 1360 is automatically enabled for completed transactions 1350 that determines how the advertising performs as a function over time and changes to the display properties associated with the presentation of the advertising. For instance, when a first set of display properties is used on a first day, and an advertisement performs according to a first statistical curve with respect to conversions, and then when a second set of display properties is used on a second day for the same advertisement, the advertisement performs according to a different statistical curve, data is implicitly collected about the performance of the first set of display properties relative to the second set of display properties.

This performance comparison enables a more granular pricing based on the display properties required for advertising transactions. The performance information 1370a and 1370b aggregated by performance tracking component 1360 can also be exposed to the participants to the transaction, i.e., the advertiser entity 1300c and publisher entity 1300f, so that the participants can better understand their transaction tradeoffs.

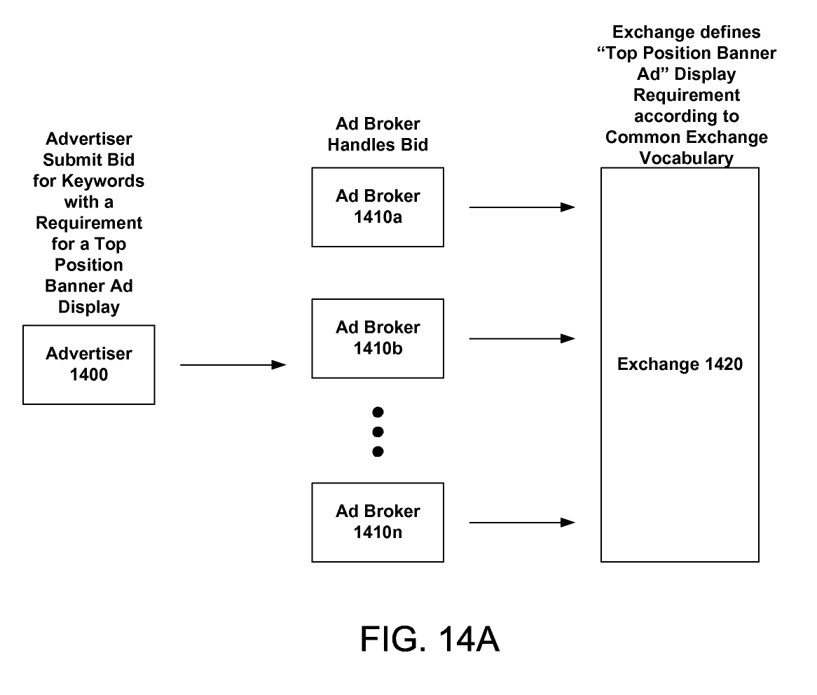

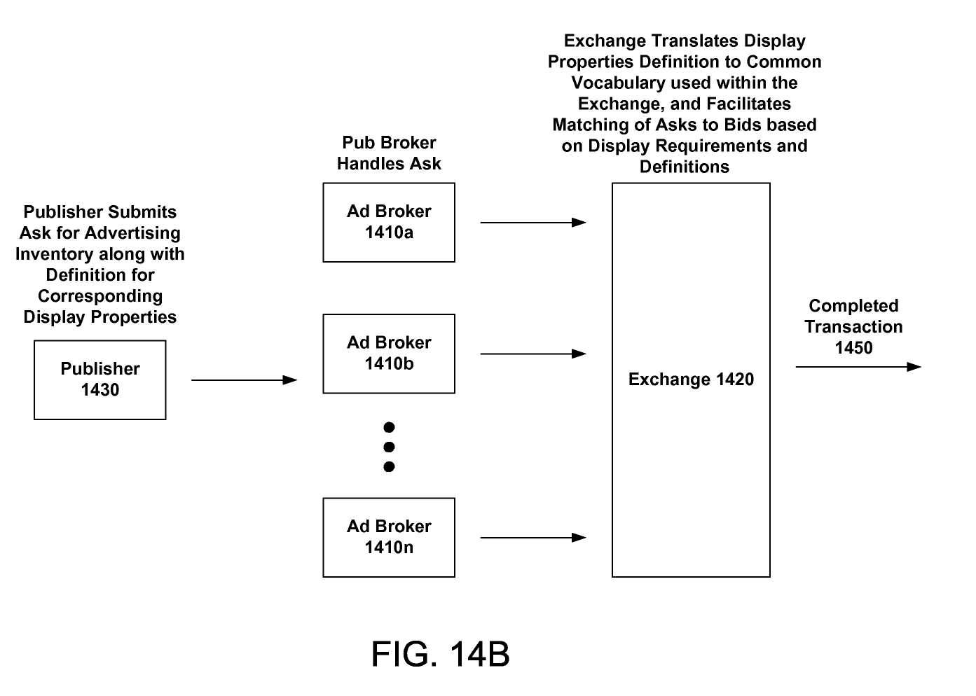

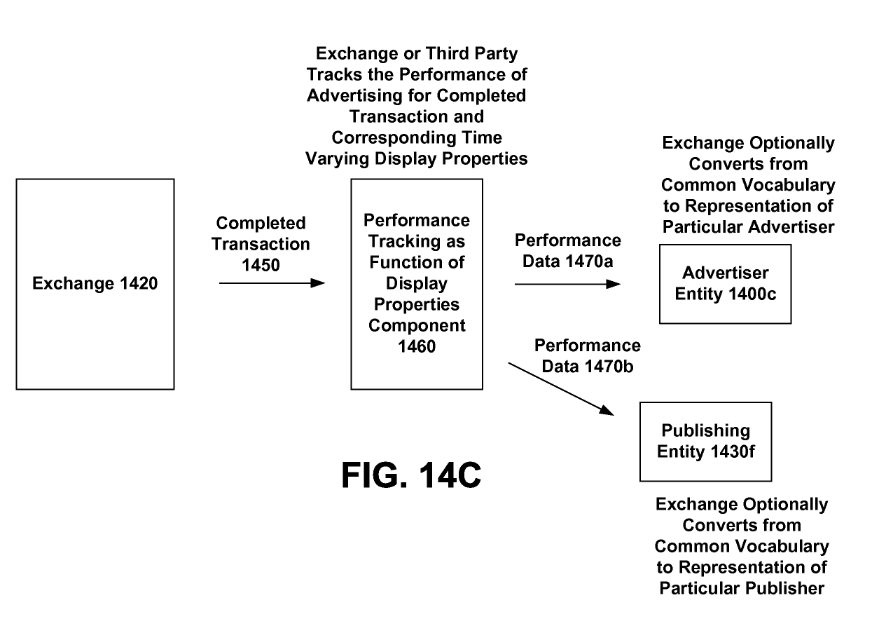

FIGS. 14A, 14B and 14C illustrate exemplary, non-limiting operation of the invention in the context of keyword bidding. As shown in FIG. 14A, advertisers 1400 submit listings with bids for keywords to Ad Brokers 1410a, 1410b, . . . , 1410n, which may include a requirement that advertising based on the keyword(s) entered by a user be displayed in a top position banner advertisement. Any of ad brokers 1410a, 1410b, . . . , 1410n handle the bid and the exchange defines the top position of a banner ad in terms of the common vocabulary defined by the exchange 1420.

Similarly, as shown in FIG. 14B, publishers 1430 submit asks for the advertising inventory to pub brokers 1440a, 1440b, . . . , 1440n along with a definition for corresponding display properties describing the way that the advertising will be displayed. The pub brokers 1440a, 1440b, . . . , 1440n submit the asks and display properties definitions to the exchange 1420, which translates the display properties definitions to the common vocabulary, e.g., a common set of categories or definitions used with the exchange 1420. The exchange 1420 then facilitates matching of asks to bids based on display requirements from advertisers 1400 and the definitions from the publishers 1430. This results in completed transactions 1450 that are matched based on display properties. In this example, a transaction 1450 is completed that matches publisher inventory that meets the “top banner ad” display requirement of the advertiser.

FIG. 14C illustrates how the common vocabulary of the exchange 1420 is then used after the transactions 1450 is completed between advertiser entity 1400c and publishing entity 1430f. In accordance with another exemplary, non-limiting aspect of the invention, conversion tracking by a performance tracking component 1460 is automatically enabled for the completed transaction 1450 that determines how the advertising performs as a function over time and changes to the display properties associated with the presentation of the advertising.

For instance, whenever a user enters the relevant keyword(s) to the publishing entity's Web page as part of search results, the publishing entity 1430f will publish the advertisement of advertiser 1400c as a top banner ad. The performance tracking component 1460 tracks the performance of the top banner ad over time as these keyword events occur, and aggregates data and trends about how the top banner ad archetype is performing. Also, if the publishing entity 1430f changes its presentation of the advertisement at issue over time, the performance tracking component 1460 will track the changes and record the impact of the presentation changes to the performance of the advertising.

This performance comparison enables a more granular pricing based on the display properties required for advertising transactions. The performance information 1470a and 1470b aggregated by performance tracking component 1460 can also be exposed to the participants to the transaction, i.e., the advertiser entity 1400c and publisher entity 1400f, so that the participants can better understand their transaction tradeoffs as a function of display properties.

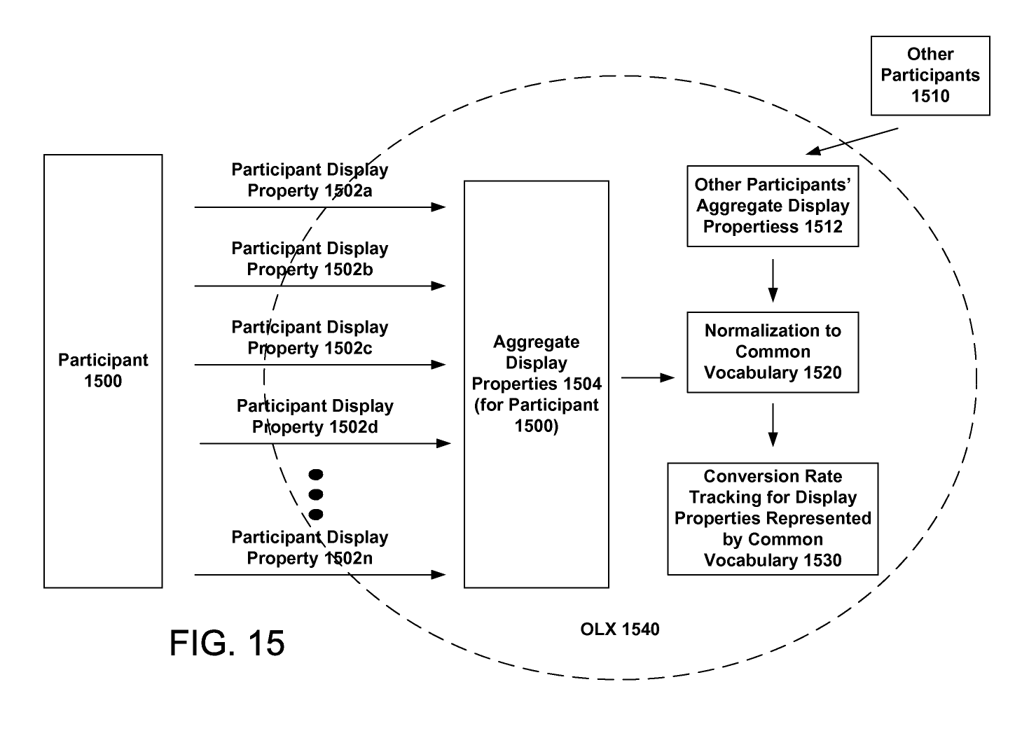

As mentioned earlier, the invention provides a variety of tools, user interfaces, application programming interfaces, etc., that enable each exchange participant to authenticate their presence on the advertising exchange, and express their individual display properties(s) to the exchange. FIG. 15 is a block diagram that shows the ability of participants to specify one or more display properties to an advertising exchange or federation 1520 in accordance with the invention. A participant 1500 can specify a variety of display properties 1502a, 1502b, 1502c, 1502d, . . . , 1502n to form an aggregate or collective display properties 1504. The participant display properties 1502a, 1502b, 1502c, 1502d, . . . , 1502n can be specific to a kind of advertising or inventory, or any other expression of a participant's preference for display properties in the exchange 1520.

Since each party has unique business goals and objectives, a wide variety of presentation objectives may be toggled, or modified in accordance with the invention to specify party display properties on a per party basis. For instance, the position of advertising on a publisher's inventory, the timing and duration of the display of advertising on the publisher's inventory, the type or kind of advertising as known in the industry, e.g., pop up, pop under, pop over (e.g., Flash media), banner ads, right rail (e.g., for sponsor ads), “above the fold,” Web search display, bottom ads (e.g., South position), Toast, Top Left, Top Right, digital billboard, top of page before content, top of page after content, Blog ad space (e.g., ads for MSN's MySpace pages), or any other kind of category of advertising inventory that is available via publisher brokers in an exchange, the size of the publishing inventory, the number of or area in pixels, the shape of the publishing inventory, the amount of other display elements in proximity to the advertising (i.e., a measure of clutter), the speed of display of the advertising (i.e., page upload speed), the quality and size of the typefont on the publisher's inventory, or any other parameter that specifies an aspect relating to the display properties for advertisements displayed at a publisher's inventory. This list is merely exemplary, and any other industry standard not listed here may also form the basis for a type of display property that may be specified or normalized in accordance with embodiments of the invention herein.

Similarly, other participants 1510 can each specify their preferences for advertising transactions via effective display properties 1512. With each of the parties' preferences invertible to a common measure, such as expected CPI, the invention can normalize the display properties of the participants to the exchange 1520, so that the transaction costs due to the participants' preferences can be understood for a given transaction. In one embodiment, these transaction costs due to the participants' display properties are expressed as a tax owing to each of the participants to the advertising transactions. For instance, a tax being received by a seller, a discount demanded by a buyer, an exchange tax, etc. can all be expressed so that the participants to a transaction can better understand the costs imposed by the different parties to the transaction. These can be published as effective tax rates 1530 for understanding these costs between the parties.

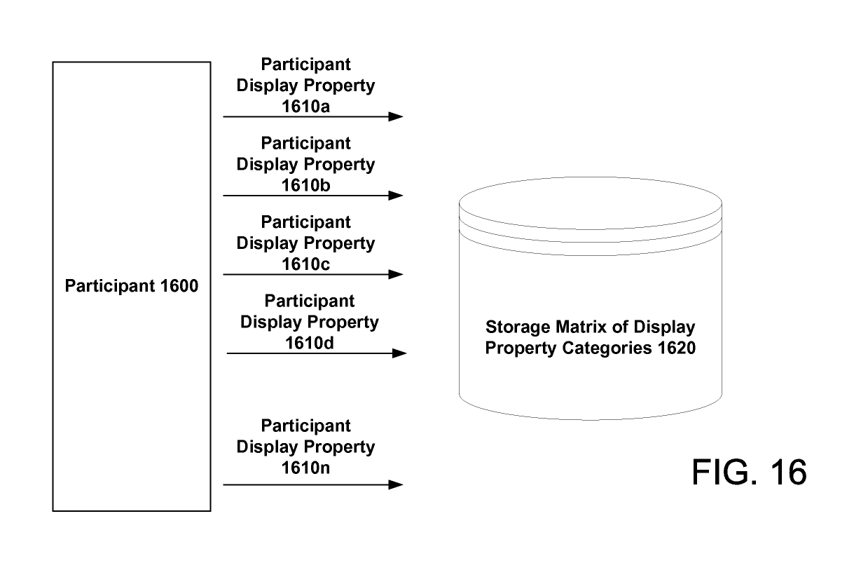

FIG. 16 is a block diagram illustrating that a participant 1600 can make choices for a display properties that relate to another participants, or other participants, such as participant display properties 1610a, 1610b, 1610c, 1610d, 1610n. The participant display properties 1610a, 1610b, 1610c, 1610d, . . . , 1610n are mapped to other participants 1660a, 1660b, 1660c, 1660d, . . . , 1660n, respectively. The participant display properties 1610a, 1610b, 1610c, 1610d, . . . , 1610n can be translated to a storage matrix of display properties 1620 that efficiently maps the display properties expressions at the participant-to-participant level.

In one embodiment, the tools enable advertisers to express the desire to opt out of each other's network. Such a choice translates into an unlimited tax penalty on transactions involving the disparate networks so that they are not pursued as part of exchange transactions. In turn, all other participants within the advertiser's networks do not have such tax penalty applied.

There are many different ways in which a participant can express a display properties. The expression can be direct (“I will not trade with Company XYZ”) or indirect (“I will not trade with small companies”, which implicates small Company XYZ). Such examples show binary display properties where a participant expresses a preference in one direction or the other. A display properties can also be expressed along a continuum, or according to any function f(x), as long as the expressions are all invertible or translatable to a common measure.

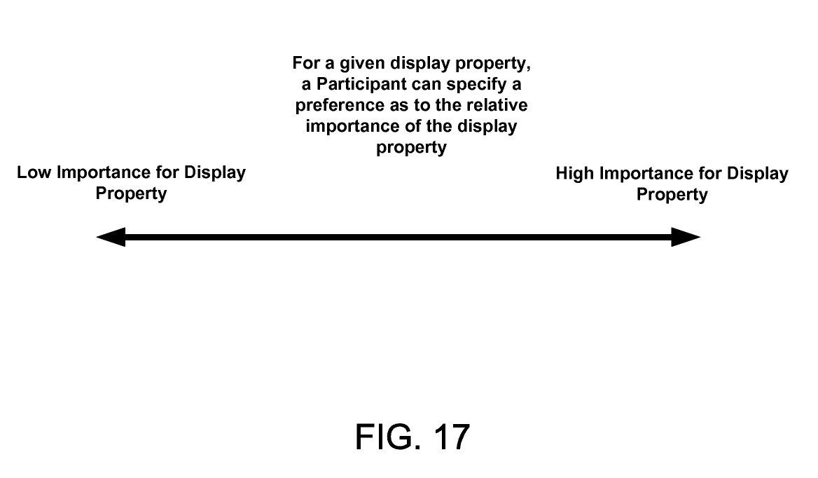

FIG. 17 shows the general concept of expressing a definition or requirement for a display property along a continuum. As mentioned, in one embodiment of the invention, all participant preferences concerning display properties are normalized to a common vocabulary. Thus, one way to express display properties in accordance with the invention is to express the importance of a presentation parameter along a continuum. A set of “knobs” are thus given to each participant that allow control of the relevance and weight of a given display property for transactions in the exchange. For instance, if “pop up” was a type of display property for publishing inventory, a participant could explicitly specify a preference to avoid the “pop up” type, to apply an agnostic view of the “pop up” display type, or to seek the “pop up” type, along a sliding scale of importance to the participant.

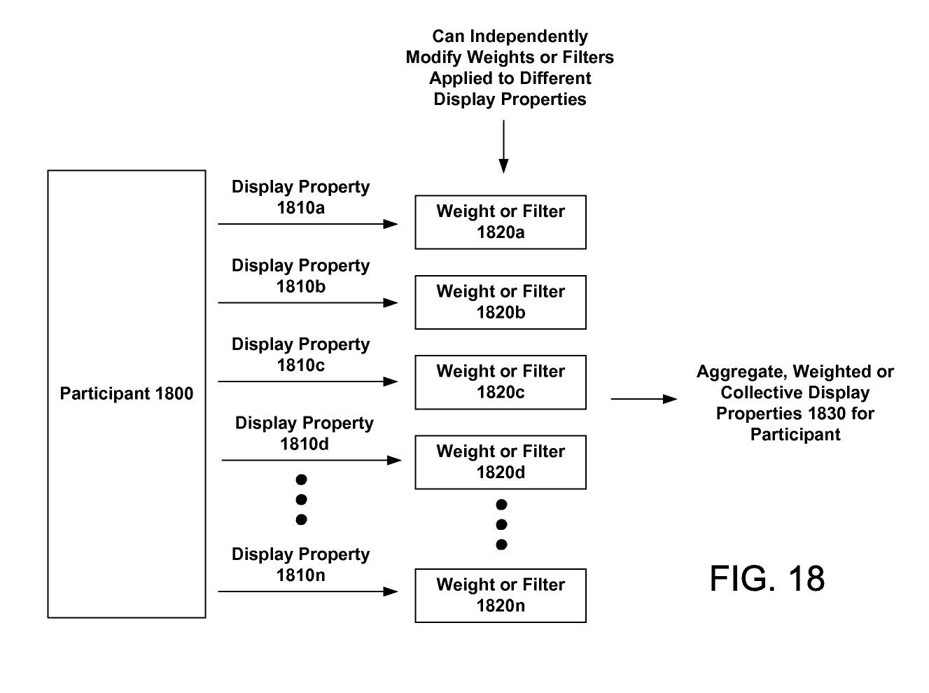

FIG. 18 is a block diagram illustrating the filtering or weighting of display properties that may be specified by a participant to an online advertising exchange in accordance with the invention. As shown, a participant 1800 may express a variety of display properties 1810a, 1810b, 1810c, 1810d, . . . , 1810n as variously described herein, however, the participant 1800 may not value all of the different kinds of display properties equally. Accordingly, a participant 1800 can adjust the effects of each of the various kinds of display properties that can be specified by the participant 1800 to the exchange. Such adjustments are made by weighting, or filtering, the different display properties with corresponding weights or filters 1820a, 1820b, 1820c, 1820d, . . . , 1820n. The weighted result is then combined into an aggregate or collective display properties 1830 for the participant. Since the weights and filters are independently adjustable, a participant 1800 can fine tune their preferences for advertising transactions by making small adjustments as their preferences with respect to display properties evolve over time. In addition, a weight of zero applied to any display properties is a statement that the particular display property is of no relevance.

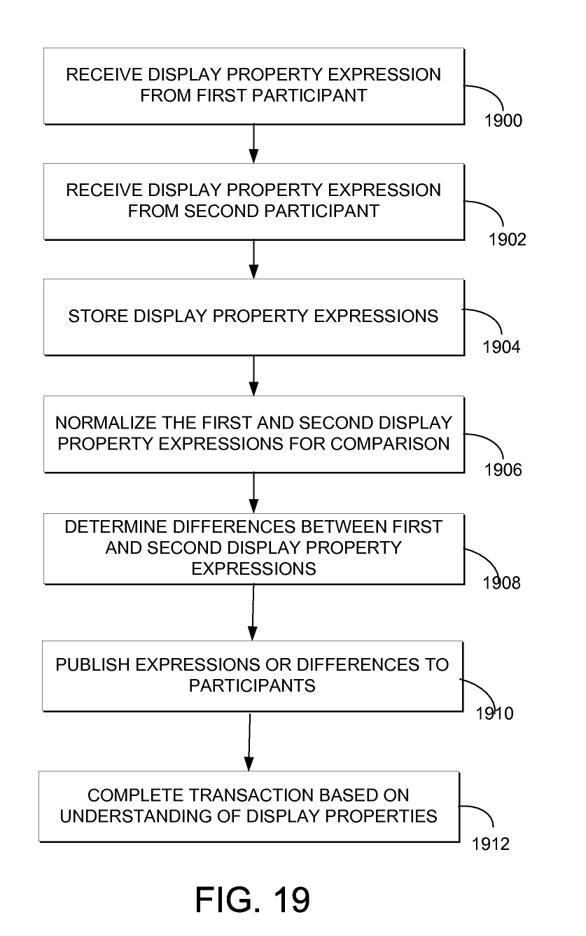

FIG. 19 is a flow diagram illustrating an exemplary process for receiving and normalizing display properties input by participants to an exchange in accordance with the invention. For instance, at 1900, a first expression of display properties is received from a first participant in the exchange. At 1902, a second expression of display properties is received from a second participant in the exchange. These display properties are stored for their respective participants at 1904. At 1906, the first and second display properties expressions are normalized for comparison within the exchange despite differing definitions of expression for the first and second sets of display properties. Optionally, at 1908, differences between the first and second display properties expressions can be determined based on the normalization, and also optionally, at 1910, the display properties can be published to the first and second participants. Lastly, at 1912, a transaction may be completed in the exchange based on the increased understanding by the first and second participant of the display properties involved with the transaction.

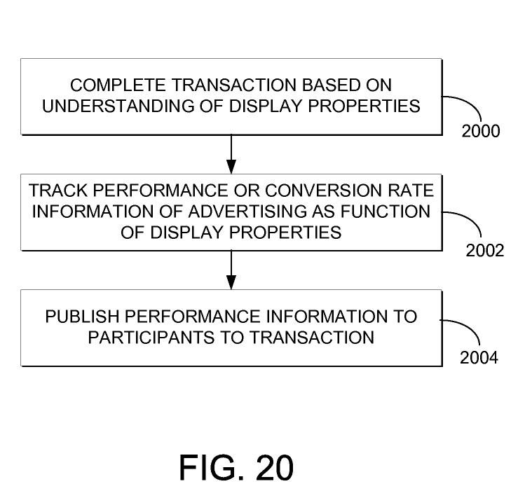

FIG. 20 is a flow diagram illustrating an exemplary process for tracking display properties as a function of display properties for transactions of an exchange in accordance with the invention. As mentioned, at 2000, based on the additional understanding of display properties, a transaction may be completed by participants to the exchange. At 2002, the performance or conversion rate of advertising as a function of display properties is tracked and then at 2004, the conversion rate or performance information may be published to the participants to the transaction.

The invention may also be implemented in a peer-to-peer architecture, wherein processing performed by the various embodiments of an exchange of the invention is shared across multiple participating machines. In such a non-limiting embodiment, each machine participating in the exchange network enabled by the invention can share some of the processing associated with normalization and tracking processes performed by the various embodiments of the on-line exchange of the invention.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

There are multiple ways of implementing the present invention, e.g., an appropriate API, tool kit, driver code, operating system, control, standalone or downloadable software object, etc. which enables applications and services to use the advertising techniques of the invention. The invention contemplates the use of the invention from the standpoint of an API (or other software object), as well as from a software or hardware object that operates according to any of the advertising techniques in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to advertise. While exemplary programming languages, names and/or examples are chosen herein as representative of various choices, these languages, names and examples are not intended to be limiting. One of ordinary skill in the art will also appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the advertising techniques of the present invention, e.g., through the use of a software object, data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described sura, methodologies that may be implemented in accordance with the disclosed subject matter will be better appreciated with reference to one or more of the figures. While for purposes of simplicity of explanation, in some cases, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide the disclosed embodiments for advertising methods. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for facilitating transactions for advertisement space in an advertising exchange including a publisher broker to represent at least one publisher and an advertiser broker to represent at least one advertiser, comprising:
receiving a first expression of display properties from a first participant in the advertising exchange according to a first standard that defines at least one requirement of the first participant pertaining to at least one display characteristic for advertising or inventory for transactions in the advertising exchange;
receiving a second expression of display properties from a second participant in the advertising exchange according to a second standard that defines at least one requirement of the second participant pertaining to at least one display characteristic for advertising or inventory for transactions in the advertising exchange; and
normalizing the first and second expressions to a standard representation for display properties within the exchange enabling a comparison of the first expression of display properties to the second expression of display properties.

2. The method of claim 1, wherein said receiving of the first expression or receiving of the second expression, or both, include:
receiving an expression of a display property that specifies a set of display properties as known in the industry, including any set of display properties known as one or more of pop up, pop under, pop over, banner ads, right rail, Web search display, bottom ads, Toast, Top Left, Top Right, digital billboard, Blog ad space

3. The method of claim 1, wherein said receiving of the first expression or receiving of the second expression, or both, include:
receiving an expression of a display property that specifies a set of display properties including any one or more of a size of publishing inventory, a shape of the publishing inventory, information about other display elements in proximity to advertising, a speed of display of the advertising, a quality or size of a typefont on the publisher's inventory.

4. The method of claim 1, further comprising:
transacting at least one transaction in the exchange by the first and second participant based on the standard representation for display properties within the exchange, enabling an understanding of a comparison of the first expression to the second expression by the first and second participants to the transacting.

5. The method of claim 4, further comprising:
for a transaction of the at least one transaction, automatically tracking conversion information that represents the performance of advertising or publishing inventory represented by the transaction based on display properties for the advertising or publishing inventory.

6. The method of claim 5, further comprising:
for a transaction of the at least one transaction, automatically tracking the performance of advertising or publishing inventory based on the display properties for advertising or publishing inventory represented by the transaction, while remaining blind to the identity of the first participant and second participant.

7. The method of claim 4, further comprising:
for a transaction of the at least one transaction, automatically tracking any changes to the display properties of the advertising or publishing inventory and tracking any differences in performance of the advertising or publishing inventory as a result of the changes.

8. The method of claim 4, further comprising:
transmitting the conversion information to the first participant, to the second participant, or to both the first participant and the second participant.

9. The method of claim 1, further comprising:
transmitting the standard representation for display properties for the second expression to the first participant; and
transmitting the standard representation for display properties for the first expression to the second participant.

10. The method of claim 9, further comprising:
translating the standard representation for display properties for the second expression to the first standard used by the first participant for the first expression; and
translating the standard representation for display properties for the first expression to the second standard used by the second participant for the second expression.

11. The method of claim 1, further comprising:
translating the first and second expressions to effective tax rates as between the first and second participants based on a comparison of the first expression to the second expression according to the standard representation.

12. The method of claim 1, further comprising:
specifying the first expression or specifying the second expression by the first or second participant, respectively, using at least one tool that receives a definition of a display preference relating to a conversion rate of advertising involved in advertising transactions.

13. A computer readable medium comprising computer executable instructions for carrying out the method of claim 1.

14. A system to facilitate trading of advertising, comprising:
a publisher broker to represent at least one publisher, wherein the publisher broker determines at least one ask for an advertisement space of the at least one publisher;
an advertiser broker to represent at least one advertiser, wherein the advertiser broker manages at least one bid for the advertisement space by the at least one advertiser; and
an exchange to facilitate a transaction for the advertisement space between the publisher broker and the advertiser broker, wherein the publisher broker and advertiser broker are from different advertising networks,
wherein a set of optimal display properties is derived from at least one presentation objective explicitly or implicitly specified by the advertiser broker on behalf of the at least one advertiser, and wherein the exchange automatically determines a set of advertisement spaces that match or nearly match the set of optimal display properties.

15. The system of claim 14, wherein the set of optimal display properties is derived from performance data representing the performance of transactions in the exchange as a function of display properties and one or more presentation goals of the participants to the transactions.

16. The system of claim 15, wherein the exchange automatically generates an advertisement with properties that satisfy or nearly satisfy the set of optimal display properties.

17. The system of claim 14, further comprising at least one tool that receives from the publisher broker or the advertiser broker a definition of at least one preference for display properties for publishing inventory of the publisher broker or advertisements for the advertiser broker, wherein the tool receives a definition of at least one presentation objective for advertising transactions of the publisher broker or the advertiser broker in the exchange.

18. The system of claim 17, wherein the at least one tool receives a definition of a preference relating to the performance for advertising or publishing inventory involved in advertising transactions.

19. A system to facilitate trading of advertising, comprising:
an exchange to facilitate a plurality of transactions for advertisement space between at least one publisher and at least one advertiser across disparate advertising networks, wherein the exchange tracks performance information over time for advertisements across disparate advertising networks based on display properties for the advertisements when published, wherein the exchange bases at least one transaction for advertisement space between the at least one publisher and the at least one advertiser based on the performance information as a function of the display properties.

20. The system according to claim 19, wherein the performance information tracked by the exchange is information about conversion rate for at least one advertisement of the plurality of transactions as a function of the display properties for the at least one advertisement when published.
